(19) United States
(12) Patent Application Publication
(10) Pub. No.: US 2026/0326284 A1
(43) Pub. Date: Oct. 22, 2026

(54) FINGER, HAND AND ROBOT APPARATUS INCLUDING THEREOF

(71) Applicant: SAMSUNG ELECTRONICS CO., LTD., Suwon-si (KR)

(72) Inventors: Donghyun KIM, Suwon-si (KR); Hyunggon SHIN, Suwon-si (KR)

(73) Assignee: SAMSUNG ELECTRONICS CO., LTD., Suwon-si (KR)

(21) Appl. No.: 19/670,528

(22) Filed: May 7, 2026

Related U.S. Application Data
(63) Continuation of application No. PCT/KR2026/005487, filed on Apr. 20, 2026.

(30) Foreign Application Priority Data
Apr. 22, 2025 (KR) 10-2025-0052398
Jul. 14, 2025 (KR) 10-2025-0094496
Mar. 23, 2026 (KR) 10-2026-0051957

(51) Int. Cl. B25J 9/10; B25J 15/00

(52) U.S. Cl. CPC B25J 9/1045; B25J 15/0009

(57) ABSTRACT

The present disclosure relates to a finger, a hand, and a robot apparatus including the same. The finger includes a plurality of frames, a plurality of shafts, an actuator, and a plurality of active pulleys connected to the actuator through at least one first cable. The at least one first cable includes an extension cable and a bending cable. When the actuator rotates in a first direction, a total length of the extension cable decreases, and when the actuator rotates in a second direction, a total length of the bending cable decreases.

### CROSS-REFERENCE TO RELATED APPLICATIONS

This application is a continuation application of International Application No. PCT/KR2026/005487, filed on Apr. 20, 2026, which is based on and claims priority to Korean Patent Application No. 10-2025-0052398, filed on Apr. 22, 2025, in the Korean Intellectual Property Office, Korean Patent Application No. 10-2025-0094496, filed on Jul. 14, 2025, in the Korean Intellectual Property Office, and Korean Patent Application No. 10-2026-0051957, filed on Mar. 23, 2026, in the Korean Intellectual Property Office, the disclosures of which are incorporated by reference herein in their entireties.

### BACKGROUND

### 1. Field

Some embodiments of the present disclosure relate to a finger including a plurality of active pulleys and plurality of passive pulleys, a hand, and a robot apparatus including thereof.

### 2. Description of Related Art

With developments in robot technology, research and development of various robot apparatuses that substitute humans in various locations such as shops, cafes, and restaurants are being actively carried out. The robot apparatuses may include humanoid robots that autonomously drive and operate without separate operation of a user, and technology is developing in a direction that raises autonomy.

### SUMMARY

According to some embodiments of the present disclosure, a finger, a hand, and a robot apparatus including thereof may be provided.

According to some embodiments of the present disclosure, a finger may include: a plurality of frames; a plurality of shafts that connect the plurality of frames to each other; an actuator; and a plurality of active pulleys at the plurality of shafts, respectively, the plurality of active pulleys connected to the actuator by at least one first cable, wherein the at least one first cable includes: an extension cable that is wound on outer circumferential surfaces of each of the plurality of active pulleys in a first direction; and a bending cable that is wound on the outer circumferential surfaces of each of the plurality of active pulleys in a second direction that is opposite to the first direction, wherein the actuator is configured to, by rotating in the first direction, cause the finger to extend by causing a length of the extension cable between two active pulleys that are adjacent to each other, among the plurality of active pulleys, to shorten, and wherein the actuator is further configured to, by rotating in the second direction, cause the finger to bend by causing a length of the bending cable between two active pulleys that are adjacent to each other, among the plurality of active pulleys, to shorten.

According to some embodiments of the present disclosure, a hand may include: a plurality of fingers; a thumb module at one side of the plurality of fingers; and a palm module including a plurality of actuators, the plurality of actuators configured to drive each of the plurality of fingers, wherein at least one from among the thumb module and the plurality of fingers includes: a plurality of frames; a plurality of shafts that connect the plurality of frames to each other; and a plurality of active pulleys at the plurality of shafts, respectively, the plurality of active pulleys connected to an actuator among the plurality of actuators by at least one first cable, wherein the at least one first cable includes: an extension cable that is wound on outer circumferential surfaces of each of the plurality of active pulleys in a first direction; and a bending cable that is wound on the outer circumferential surfaces of each of the plurality of active pulleys in a second direction that is opposite to the first direction, wherein the actuator is configured to, by rotating in the first direction, cause the at least one from among the thumb module and the plurality of fingers to extend by causing a length of the extension cable between two active pulleys that are adjacent to each other, among the plurality of active pulleys, to shorten, and wherein the actuator is further configured to, by rotating in the second direction, cause the at least one from among the thumb module and the plurality of fingers to bend by causing a length of the bending cable between two active pulleys that are adjacent to each other, among the plurality of active pulleys, to shorten.

According to some embodiments of the present disclosure, a robot apparatus, may include: a main body; a driving apparatus configured to move the main body; a robot arm at one side of the main body; and a hand connected to the robot arm, wherein the hand includes: a plurality of fingers; a thumb module at one side of the plurality of fingers; and a palm module including a plurality of actuators, the plurality of actuators configured to drive each of the plurality of fingers, wherein at least one from among the thumb module and the plurality of fingers includes: a plurality of frames; a plurality of shafts that connect the plurality of frames to each other; and a plurality of active pulleys at the plurality of shafts, respectively, the plurality of active pulleys connected to an actuator among the plurality of actuators by at least one first cable, wherein the at least one first cable includes: an extension cable that is wound on outer circumferential surfaces of each of the plurality of active pulleys in a first direction; and a bending cable that is wound on outer circumferential surfaces of each of the plurality of active pulleys in a second direction that is opposite to the first direction, wherein the actuator is configured to, by rotating in the first direction, cause the at least one from among the thumb module and the plurality of fingers to extend by causing a length of the extension cable between two active pulleys that are adjacent to each other, among the plurality of active pulleys, to shorten, and wherein the actuator is further configured to, by rotating in the second direction, cause the at least one from among the thumb module and the plurality of fingers to bend by causing a length of the bending cable between two active pulleys that are adjacent to each other, among the plurality of active pulleys, to shorten.

Additional embodiments of the present disclosure may be described or understood from the detailed description below.

### BRIEF DESCRIPTION OF DRAWINGS

Aspects, features, and advantages of embodiments of the present disclosure will be made clearer through descriptions below with reference to the accompanied drawings. In the accompanied drawings:

FIG. 1 is a diagram illustrating a robot apparatus according to at least one example embodiment of the present disclosure;

FIG. 2 is a diagram illustrating a structure of a hand according to at least one example embodiment of the present disclosure;

FIG. 3 is a diagram illustrating a structure of a hand according to at least one example embodiment of the present disclosure;

FIG. 4 is a diagram illustrating a structure of a finger according to at least one example embodiment of the present disclosure;

FIG. 5 is a diagram illustrating a structure of a finger according to at least one example embodiment of the present disclosure;

FIG. 6 is a diagram illustrating a coupling relationship of a plurality of active pulleys among a structure of a finger according to at least one example embodiment of the present disclosure;

FIG. 7 is a diagram illustrating a structure of each of a plurality of active pulleys according to at least one example embodiment of the present disclosure;

FIG. 8 is a diagram illustrating a structure of an active drive pulley coupled to actuators according to at least one example embodiment of the present disclosure;

FIG. 9 is a diagram illustrating a tension member according to at least one example embodiment of the present disclosure;

FIG. 10 is a diagram illustrating a grasping operation of a finger according to an operation of an actuator according to at least one example embodiment of the present disclosure;

FIG. 11 is a diagram illustrating a coupling relationship of a plurality of passive pulleys among a structure of a finger according to at least one example embodiment of the present disclosure;

FIG. 12 is a diagram illustrating an operation of a finger by an LUM cable according to at least one example embodiment of the present disclosure;

FIG. 13 is a diagram illustrating a force acting on a finger by an LUM cable according to at least one example embodiment of the present disclosure;

FIG. 14 is a diagram illustrating a structure of a second passive pulley according to at least one example embodiment of the present disclosure;

FIG. 15 is a diagram illustrating a structure of a passive drive pulley according to at least one example embodiment of the present disclosure;

FIG. 16 is a diagram illustrating a coupling relationship of a plurality of passive pulleys among a structure of a finger according to at least one example embodiment of the present disclosure;

FIG. 17 is a diagram illustrating a coupling relationship of a plurality of passive pulleys among a structure of a finger according to at least one example embodiment of the present disclosure;

FIG. 18 is a diagram illustrating a coupling relationship of a plurality of passive pulleys among a structure of a finger according to at least one example embodiment of the present disclosure;

FIG. 19 is a diagram illustrating a coupling relationship of an active pulley among a structure of a thumb module according to at least one example embodiment of the present disclosure;

FIG. 20 is a diagram illustrating a coupling relationship of a passive pulley among a structure of a thumb module according to at least one example embodiment of the present disclosure;

FIG. 21 is a diagram illustrating an operation of a thumb module by a passive pulley according to at least one example embodiment of the present disclosure;

### DETAILED DESCRIPTION

Various example embodiments of the present disclosure described below, and terms used in the present disclosure, are not intended to limit the scope of the present disclosure. Various modifications, equivalents, and alternatives of the example embodiments are included within the spirit and scope of the present disclosure.

With respect to the description of drawings, like reference numerals may be used for like or associated elements.

A singular form of a noun corresponding to an item may include one or a plurality of the items, unless otherwise specified.

In the present disclosure, phrases such as “A or B,” “at least one of A and B,” “at least one of A or B,” “A, B, or C,” “at least one of A, B, and C,” and “at least one of A, B, or C” may respectively include any one or all possible combinations thereof of the items listed together with the relevant phrase among the phrases.

The term “and/or” may include a combination of a plurality of related elements described or any element among the plurality of related elements described.

Terms such as “1st,” “2nd,” or “first” or “second” may be used to simply distinguish a relevant element from another relevant element, and not limit the relevant elements in other aspects (e.g., importance or order).

When a certain (e.g., first) element is indicated as being “coupled with/to” or “connected to” another (e.g., second) element, together with or without terms such as “operatively” or “communicatively,” it may be understood as the certain element being coupled with/to the another element directly (e.g., via wire), wirelessly, or through a third element.

It is to be understood that the terms such as “have,” “include,” and “comprise” are used herein to designate a presence of a characteristic, a number, a step, an operation, an element, a component, or a combination thereof, and not to preclude a presence or a possibility of adding one or more of other characteristics, numbers, steps, operations, elements, components or a combination thereof.

When a certain element is described as “coupled,” “combined,” “supported,” or “contacted” with another element, the above may include not only the elements being directly coupled, combined, supported, or contacted, but also being indirectly coupled, combined, supported, or contacted through a third element.

When a certain element may be described as positioned “on” another element, the above may include not only the certain element being directly contacted to the other element, but also an element being present between the two elements.

A finger, a hand, and a robot apparatus including thereof according to various embodiments of the present disclosure will be described in detail with reference to the drawings below.

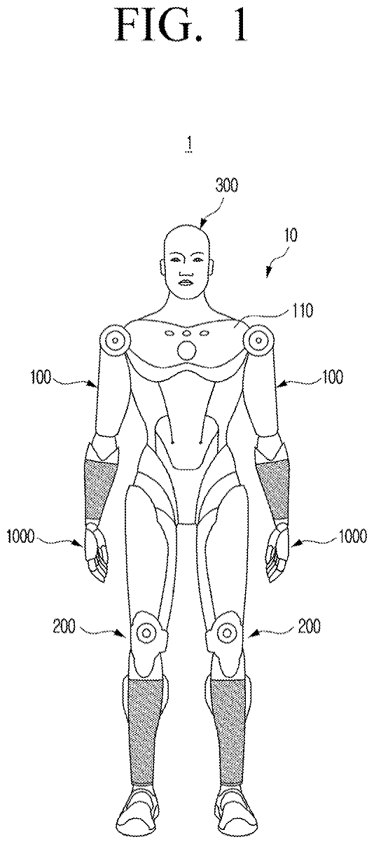

FIG. 1 is a diagram illustrating a robot apparatus 1 according to at least one example embodiment of the present disclosure.

In FIG. 1, the robot apparatus 1 may be an apparatus configured to automatically perform a complex operation.

The robot apparatus 1 may include various types such as, for example, and without limitation, an industrial robot used in an industrial process, a service robot configured to support or substitute human activity, an exploration robot used to explore a difficult environment or a location difficult to access, a household robot for assisting daily lives of individuals, and the like.

In addition, the robot apparatus 1 may include a humanoid robot configured to simulate a human form or function.

Referring to FIG. 1, the robot apparatus 1 may include a main body 10, at least one robot arm 100, at least one driving apparatus 200, a robot head 300 including at least one sensor, and a hand 1000.

The main body 10 may be a configuration that includes apparatuses for managing the overall operation of the robot apparatus 1. The main body 10 may be an apparatus that forms an exterior of the robot apparatus 1. In FIG. 1, the main body 10 may include the robot head 300, a robot body 110, the at least one robot arm 100, and the at least one driving apparatus 200.

The robot head 300 may be a component corresponding to a head portion of the robot apparatus 1, and may include devices for interaction with a human, such as a sensor, a camera, a voice recognition microphone, and a display for expressing a facial expression of the robot apparatus 1. The robot head 300 may be disposed on an upper side of the robot body 110.

The robot head 300 may include at least one sensor. The robot head 300 may detect the surrounding environment based on sensing values of at least one sensor. The at least one sensor may be formed integrally with the robot head 300, or formed in a form disposed inside of the robot head 300. The robot head 300 may be detached from or attached to the main body 10.

The robot body 110 may be an apparatus for protecting various key configurations of the robot apparatus 1 disposed therein. The robot body 110 may be disposed at a bottom side of the robot head 300. The robot body 110 may be disposed at the center of the robot apparatus 1. The robot body 110 may be disposed with at least one robot arm 100 at one side thereof. For example, as shown in FIG. 1, the robot body 110 may be disposed with two robot arms 100 at opposite sides thereof.

The main body 10 may include at least one driving apparatus 200 at the bottom side of the robot body 110.

The at least one driving apparatus 200 may be a configuration that allows for the robot apparatus 1 to walk or move. The at least one driving apparatus 200 may be formed in various forms according to user intent.

For example, as shown in FIG. 1, if a manufacturer of the robot apparatus 1 manufactures the robot apparatus 1 to be a humanoid robot, the at least one driving apparatus 200 may be formed in a form that includes two legs.

If the manufacturer manufactured the robot apparatus 1 to be a four-leg walking robot, the at least one driving apparatus 200 may be formed in a form that includes four legs.

If the manufacturer manufactured the robot apparatus 1 to be a driving robot, the at least one driving apparatus 200 may be formed in a form that includes a plurality of wheels.

The at least one sensor may be disposed on a front surface of the robot head 300. The at least one sensor may include an image sensor. The at least one sensor may be formed as various sensors such as a camera and a red, green, and blue (RGB) sensor. The at least one sensor may generate a captured image.

The robot apparatus 1 may identify characteristics and the like of an object such as a target and the like through the captured image generated from the at least one sensor. Specifically, the robot apparatus 1 may extract a representative value of pixels included in each pixel group after dividing all of the pixels in the captured image that is generated from the at least one sensor into a plurality of pixel groups.

Then, the robot apparatus 1 may identify a position of a pixel group having pixel representative values that is within similar ranges with one another, and identify, based on a plurality of similar pixel groups being positioned consecutively, the similar pixel groups as forming an edge with respect to one object.

Then, the robot apparatus 1 may estimate what is the object based on a shape of the edge, and pixel values of pixels that belong in the edge, and the like, and identify a distance from the object, and the like based on a size of the edge. Based therefrom, the robot apparatus 1 may identify characteristics and the like of the object.

The at least one robot arm 100 may be disposed at the main body 10. Specifically, the at least one robot arm 100 may be coupled at one side of the robot body 110. The at least one robot arm 100 may be configured to move and rotate each of at least one joint to move the hand 1000 to a specific position.

The at least one robot arm 100 may be formed integrally with the main body 10, or may be formed in a form that is present as an independent module from the main body 10 and assembled to the main body 10. The at least one robot arm 100 may include at least one joint, and may be connected to the hand 1000.

The at least one joint of the at least one robot arm 100 may move variously about shafts. The at least one joint may be formed as modules of various forms such as, for example, and without limitation, an I-type module, an L-type module, and the like.

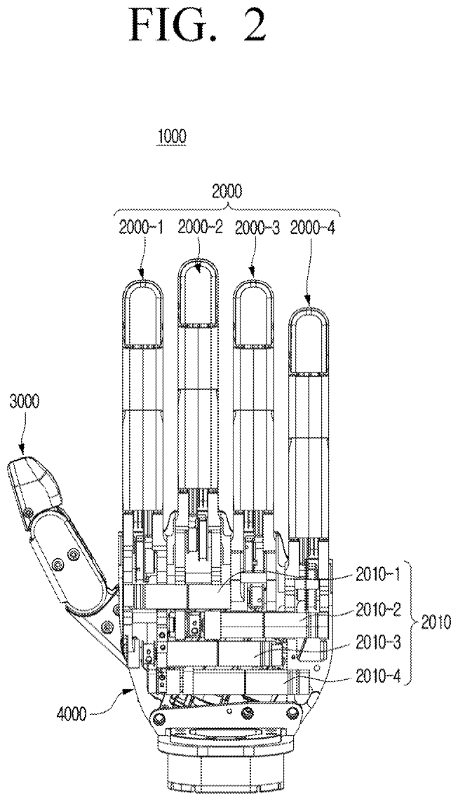

FIG. 2 is a diagram illustrating a structure of the hand 1000 according to at least one example embodiment of the present disclosure.

The hand 1000 may be a module for gripping a target, an object, or the like. In other words, the hand 1000 may be a module with which the robot apparatus 1 directly interacts with an object or environment in order to perform a specific operation.

In addition to the hand 1000, depending on a type or a form of a gripper (e.g., a two-finger gripper, a three-finger gripper, etc.) and other modules, the robot apparatus 1 may perform various operations such as grasping an object, tapping, or drilling a hole. In various example embodiments of the present disclosure, the hand 1000 is shown and described as including one thumb and four fingers like a hand of a human. However, embodiments of the present disclosure are not limited thereto.

The hand 1000 may include fingers 2000, a thumb module 3000, and a palm module 4000.

The fingers 2000 may be a configuration that corresponds to fingers of a human, may be a configuration capable of gripping a target or an object. However, the fingers 2000 may perform various operations that not only include gripping, but also pinching, touching, sliding, compressing, and the like.

The fingers 2000 may be expressed in various terms such as, for example, and without limitation, a plurality of fingers, at least one finger, and the like according to the number of fingers 2000. However, in the present disclosure, the fingers 2000 will be collectively described as fingers 2000 for convenience of description.

With reference to FIG. 2, the finger 2000 may include four fingers. For example, the finger 2000 may include an index finger 2000-1, a middle finger 2000-2, a ring finger 2000-3, and a little finger 2000-4 (e.g., a pinky finger).

Each of the index finger 2000-1, the middle finger 2000-2, the ring finger 2000-3, and the little finger 2000-4 may be formed with a function, size, and form corresponding to the function, size and form of human fingers.

The palm module 4000 may be a configuration that corresponds to a palm of a hand of a human. The palm module 4000 may include actuators 2010 and the like for driving the fingers 2000.

The actuator 2010 may include an index finger actuator 2010-1 configured to drive each joint of the index finger 2000-1, a middle finger actuator 2010-2 configured to drive each joint of the middle finger 2000-2, a ring finger actuator 2010-3 configured to drive each joint of the ring finger 2000-3, and a little finger actuator 2010-4 configured to drive each joint of the little finger 2000-4.

As shown in FIG. 2, the actuators 2010 may be horizontally aligned with respect to each other in the palm module 4000. For example, the actuators 2010 may extend parallel to each other in a direction crossing (e.g., perpendicular to) an extending direction (e.g., a length direction) of the fingers 2000.

For example, the index finger actuator 2010-1, the middle finger actuator 2010-2, the ring finger actuator 2010-3, and the little finger actuator 2010-4 may be horizontally aligned consecutively. For example, the actuators 2010, which are horizontally aligned, may be disposed with the index finger actuator 2010-1 at the upper most side thereof, the middle finger actuator 2010-2, the ring finger actuator 2010-3, and the little finger actuator 2010-4 in consecutive order below thereof. However, embodiments of the present disclosure are not limited thereto, and the actuators 2010, which are horizontally aligned, may be disposed such that each of the actuators 2010 are in various orders according to a configuration by the manufacturer.

The thumb module 3000 may be disposed at one side of the index finger 2000-1. For example, in the case of the hand 1000 corresponding to a right hand, the thumb module 3000 may be disposed at a left side of the index finger 2000-1. Conversely, in the case of the hand 1000 corresponding to a left hand, the thumb module 3000 may be disposed at a right side of the index finger 2000-1.

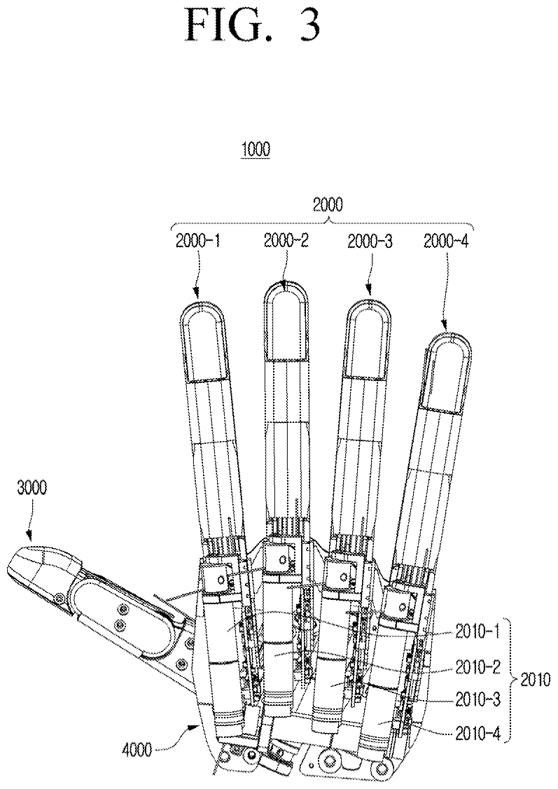

FIG. 3 is a diagram illustrating a structure of the hand 1000 according to at least one example embodiment of the present disclosure.

The hand 1000 may include the fingers 2000, the thumb module 3000, and the palm module 4000.

Because the overall description about the finger 2000, the thumb module 3000, and the palm module 4000 has been described above, repeated descriptions thereof may be omitted.

In the palm module 4000, the actuators 2010 may be may be vertically aligned with respect to each other in the palm module 4000. The actuators 2010 may be aligned respectively at positions extended along a length direction of the fingers 2000. For example, the actuators 2010 may extend parallel to each other in the extending direction (e.g., the length direction) of the fingers 2000.

For example, the index finger actuator 2010-1, the middle finger actuator 2010-2, the ring finger actuator 2010-3, and the little finger actuator 2010-4 may be vertically aligned consecutively.

In other words, the index finger actuator 2010-1, the middle finger actuator 2010-2, the ring finger actuator 2010-3, and the little finger actuator 2010-4 may be disposed in vertical alignment at positions extended along length directions of each of the index finger 2000-1, the middle finger 2000-2, the ring finger 2000-3, and the little finger 2000-4.

For example, the actuators 2010, which are vertically aligned, may be disposed with the index finger actuator 2010-1 at the far left side, and the middle finger actuator 2010-2, the ring finger actuator 2010-3, and the little finger actuator 2010-4 consecutively from the right side thereafter. However, embodiments of the present disclosure are not limited thereto, and the actuators 2010, which are vertically aligned, may be disposed such that each of the actuators 2010 are in various orders according to a configuration by the manufacturer.

The thumb module 3000 may be disposed at one side of the index finger 2000-1. For example, in the case of the hand 1000 corresponding to the right hand, the thumb module 3000 may be disposed at the left side of the index finger 2000-1. Conversely, in case of the hand 1000 corresponding to the left hand, the thumb module 3000 may be disposed at the right side of the index finger 2000-1.

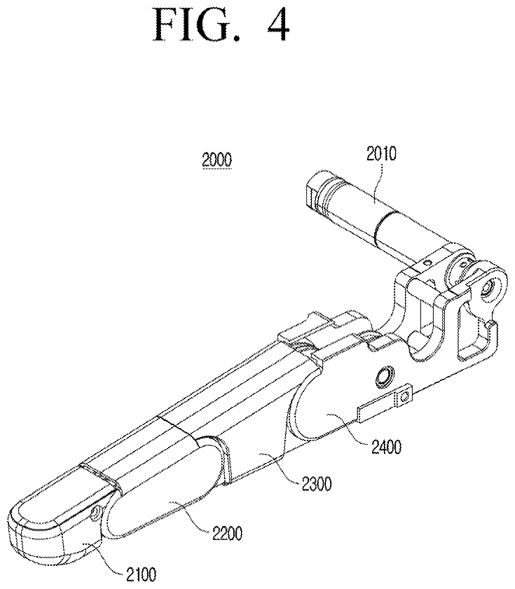

FIG. 4 is a diagram illustrating a structure of the finger 2000 according to at least one example embodiment of the present disclosure.

Because each of the fingers 2000 shown in FIG. 2 and FIG. 3 respectively may have the same structure, one finger 2000 will be representatively described with reference to FIG. 4 and thereafter.

In FIG. 4, the finger 2000 may include a plurality of frames.

The plurality of frames may be a configuration that forms an exterior of the finger 2000. In other words, the plurality of frames may be a configuration that form a skeleton (or framework) of the finger 2000. The plurality of frames may be in direct contact with a target, an object, or the like when gripping the target, the object, or the like. In addition, the plurality of frames may be configured to protect components inside of the finger 2000.

The plurality of frames may include a first frame 2100, a second frame 2200, a third frame 2300, and a fourth frame 2400.

The first frame 210 may be a configuration that forms the skeleton of an outermost phalanx of the finger 2000. The first frame 2100 may be otherwise expressed as a tip frame, a distal phalanx (PH), or the like.

The second frame 2200 may be a configuration that forms the skeleton of a second phalanx that is directly connected to the outermost phalanx. The second frame 2200 may be expressed as a middle frame, a middle PH (a middle Phalanx), and the like.

The third frame 2300 may be a configuration that form the skeleton of a third phalanx that is connected to the first frame 210 by the second frame 2200. The third frame 2300 may be expressed as a proximal frame, a proximal PH (a proximal Phalanx), and the like.

The fourth frame 2400 may be a configuration that forms the skeleton of a fourth phalanx that is connected to the first frame 210 by the second frame 2200 and the third frame 2300. The fourth frame 2400 may be a configuration that is in direct contact with the palm module 4000. The fourth frame 2400 may be expressed as a base frame, a base PH (a base Phalanx), and the like.

The fourth frame 2400 may be coupled with the actuators 2010. Accordingly, the actuators 2010 may be connected with various configurations disposed inside the fingers 2000 through cables, and drive each phalanx of the fingers 2000 and the plurality of frames of the fingers 2000.

With reference to FIG. 4, the first frame 2100 may rotate about a point (or a shaft) connected with the second frame 2200. Here, a point at which the first frame 2100 and the second frame 2200 are connected may be expressed as a distal interphalangeal (DIP) or a tip joint.

The second frame 2200 may rotate about a point (or a shaft) connected with the third frame 2300. Here, a point at which the second frame 2200 and the third frame 2300 are connected may be expressed as a proximal interphalangeal (PIP) or a middle joint.

The third frame 2300 may rotate about a point (or a shaft) connected with the fourth frame 2400. Here, a point at which the third frame 2300 and the fourth frame 2400 are connected may be expressed as a metacarpophalan geal (MCP) or a base joint.

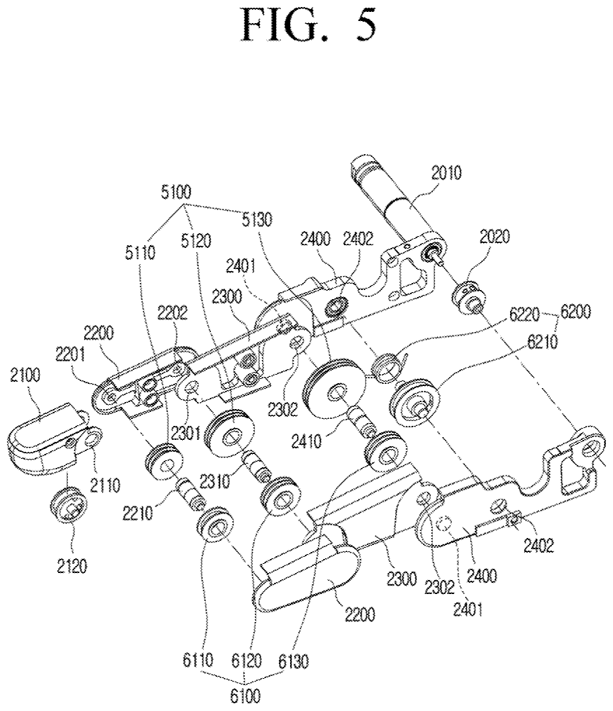

FIG. 5 is a diagram illustrating a structure of the finger 2000 according to at least one example embodiment of the present disclosure.

Referring to FIG. 5, the fingers 2000 may include the plurality of frames, a plurality of shafts, a plurality of active pulleys 5100, a plurality of passive pulleys 6100, a tension member 2120 (e.g., a tensioner), the actuators 2010, and a spring module 6200.

Because detailed description about the plurality of frames has been provided above with reference to FIG. 4, repeated descriptions thereof may be omitted.

With reference to FIG. 5, the plurality of shafts may be a configuration that functions as a rotation shaft at a point at which each of the frames are connected with one another.

The plurality of shafts may include a first shaft 2210, a second shaft 2310, and a third shaft 2410.

The first shaft 2210 may be disposed at the distal interphalangeal (DIP), which may be the point at which the first frame 2100 and the second frame 2200 are connected.

The first shaft 2210 may couple the first frame 2100 and the second frame 2200. The first shaft 2210 may be configured such that the first frame 2100 and the second frame 2200 are coupled. The first shaft 2210 may be configured to connect the first frame 2100 and the second frame 2200 to each other. The second frame 2200 may be disposed at opposite outer sides of the first frame 2100. The first shaft 2210 may be inserted into a first hole 2110 formed in the first frame 2100. In addition, opposite ends of the first shaft 2210 may be coupled to a 2-1 hole 2201 of the second frame 2200. Accordingly, the first shaft 2210 may be configured to couple the first frame 2100 and the second frame 2200. In addition, the first shaft 2210 may be coupled with a first active pulley 5110 among the plurality of active pulleys 5100. The first shaft 2210 may be coupled with a first passive pulley 6110 among the plurality of passive pulleys 6100. The first active pulley 5110 and the first passive pulley 6110 may be disposed in parallel between first holes 2110 formed at opposites ends of the first frame 2100.

Here, the first active pulley 5110 and the first passive pulley 6110 may be disposed in parallel on the first shaft 2210, and may be rotated independently from one another.

The second shaft 2310 may be disposed at the proximal interphalangeal (PIP), which may be the point at which the second frame 2200 and the third frame 2300 are connected.

The second shaft 2310 may couple the second frame 2200 and the third frame 2300. The second shaft 2310 may be configured to connect the second frame 2200 and the third frame 2300 to each other. The third frame 2300 may be disposed at opposite inner sides of the second frame 2200. The second shaft 2310 may be inserted into a 3-1 hole 2301 formed in the third frame 2300. In addition, opposite ends of the second shaft 2310 may be coupled to a 2-2 hole 2202 of the second frame 2200. Accordingly, the second shaft 2310 may be configured to couple the second frame 2200 and the third frame 2300.

In addition, the second shaft 2310 may be coupled with a second active pulley 5120 among the plurality of active pulleys 5100. The second shaft 2310 may be coupled with a second passive pulley 6120 among the plurality of passive pulleys 6100.

The second active pulley 5120 and the second passive pulley 6120 may be disposed in parallel between 3-1 holes 2301 of the third frame 2300.

Here, the second active pulley 5120 and the second passive pulley 6120 may be disposed in parallel on the second shaft 2310, and may be rotated independently from one another.

The third shaft 2410 may be disposed at the metacarpophalan geal (MCP), which may be the point at which the third frame 2300 and the fourth frame 2400 are connected.

The third shaft 2410 may couple the third frame 2300 and the fourth frame 2400. The third shaft 2410 may be configured to connect the third frame 2300 and the fourth frame 2400 to each other. The third frame 2300 may be disposed at opposite inner sides of the fourth frame 2400. The third shaft 2410 may be inserted into a 3-2 hole 2302 formed in the third frame 2300. In addition, opposite ends of the third shaft 2410 may be coupled to a 4-1 hole 2401 of the fourth frame 2400. Accordingly, the third shaft 2410 may be configured to couple the third frame 2300 and the fourth frame 2400.

In addition, the third shaft 2410 may be coupled with a third passive pulley 6130 among the plurality of passive pulleys 6100.

Here, a third active pulley 5130 and the third passive pulley 6130 may be disposed in parallel on the third shaft 2410, and may be rotated independently from one another.

The plurality of active pulleys 5100 may be a configuration that is disposed at each of the plurality of shafts, and connected with the actuators 2010 by at least one first cable. The plurality of active pulleys 5100 may perform a role for maintaining momentum tension of the at least one first cable.

Here, the momentum tension may be a tension state formed as the at least one first cable is coupled to be wound around each of the plurality of active pulleys 5100. Accordingly, the at least one first cable may continuously maintain tension formed in the at least one cable according to driving of the actuator 2010.

The plurality of active pulleys 5100 may include the first active pulley 5110, which may be connectable to the first shaft 2210 positioned at a distal interphalangeal (DIP) joint among the plurality of shafts.

The plurality of active pulleys 5100 may include the second active pulley 5120, which may be connected to the second shaft 2310 positioned at a proximal interphalangeal (PIP) joint among the plurality of shafts.

The plurality of active pulleys 5100 may include the third active pulley 5130, which may be connected to the third shaft 2410 positioned at a metacarpophalangeal (MCP) joint among the plurality of shafts.

The plurality of active pulleys 5100 may be connected with one another through the at least one first cable. A detailed description of a connection relationship of the plurality of active pulleys 5100 and the at least one first cable will be provided below.

The plurality of passive pulleys 6100 may be a configuration that is disposed at each of the plurality of shafts, and connected with one another by at least one second cable. The plurality of passive pulleys 6100 may perform a role for maintaining momentum tension of the at least one second cable.

The plurality of passive pulleys 6100 may include the first passive pulley 6110, which may be connectable to the first shaft 2210 positioned at the distal interphalangeal (DIP) joint among the plurality of shafts.

The plurality of passive pulleys 6100 may include the second passive pulley 6120, which may be connected to the second shaft 2310 positioned at the proximal interphalangeal (PIP) joint among the plurality of shafts.

The plurality of passive pulleys 6100 may include the third passive pulley 6130, which may be connected to the third shaft 2410 positioned at the metacarpophalangeal (MCP) joint among the plurality of shafts.

The plurality of passive pulleys 6100 may be connected with one another through the at least one second cable. A detailed description of a connection relationship of the plurality of passive pulleys 6100 and the at least one second cable will be provided below.

The plurality of passive pulleys 6100 may be connected to the spring module 6200 by the at least one second cable.

The tension member 2120 may be disposed inside of the first frame 2100. The tension member 2120 may be a configuration that applies tension to the at least one first cable for the at least one first cable to not be deviated from the plurality of active pulleys 5100 when the at least one first cable connected to the plurality of active pulleys 5100 rotates according to driving of the actuators 2010.

The tension member 2120 may be disposed on a same virtual line as with the plurality of active pulleys 5100.

A detailed description of a connection relationship of the tension member 2120, the plurality of active pulleys 5100, and the at least one first cable will be provided below.

An actuator 2010 may include an active drive pulley 2020. The active drive pulley 2020 may be disposed at one side of the actuator 2010. The active drive pulley 2020 may be a configuration that is disposed on the same virtual line as the plurality of active pulleys 5100, and may be capable of performing a role of connecting the at least one first cable, connected to the plurality of active pulleys 5100, to the actuator 2010.

The spring module 6200 may include a passive drive pulley 6210 and a torsion spring 6220.

The passive drive pulley 6210 may be a configuration that is disposed on the same virtual line as the plurality of passive pulleys 6100, and may be capable of being connected with the at least one second cable.

The passive drive pulley 6210 may be connected with the torsion spring 6220 at one side thereof. Accordingly, the spring module 6200 may restore, when external force applied to the plurality of frames is removed, the rotated plurality of passive pulleys 6100.

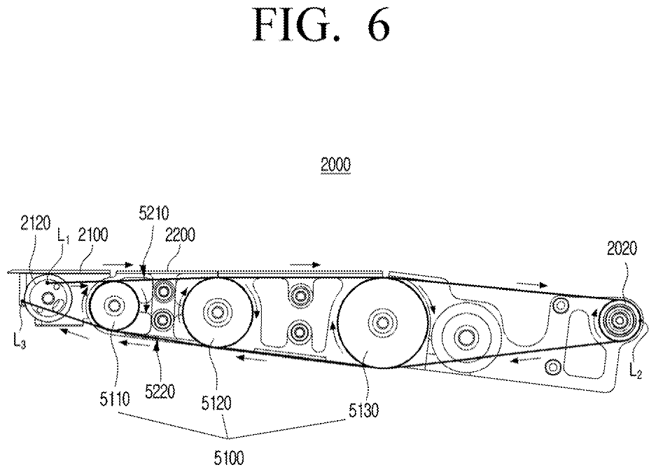

FIG. 6 is a diagram illustrating a coupling relationship of the plurality of active pulleys 5100 among a structure of the finger 2000 according to at least one example embodiment of the present disclosure.

A finger 2000 may include the plurality of active pulleys 5100, the tension member 2120, and the actuator 2010.

The plurality of active pulleys 5100 may include the first active pulley 5110 mounted to the first shaft 2210 positioned at the DIP, the second active pulley 5120 mounted to the second shaft 2310 positioned at the PIP, and the third active pulley 5130 mounted to the third shaft 2410 positioned at the MCP.

The second active pulley 5120 may have a bigger size than a size of the first active pulley 5110, and the third active pulley 5130 may have a bigger size than a size of the second active pulley 5120.

The actuator 2010 may include the active drive pulley 2020 at one side thereof. The active drive pulley 2020 may be disposed at a side of the third active pulley 5130 that faces away from the second active pulley 5120. For example, the third active pulley 5130 may be between the second active pulley 5120 and the active drive pulley 2020.

The tension member 2120 may be disposed at a side of the first active pulley 5110 that faces away from the second active pulley 5120. For example, the first active pulley 5110 may be between the tension member 2120 and the second active pulley 5120.

The plurality of active pulleys 5100 may be disposed at each of the plurality of shafts, and connected with the actuators 2010 through the at least one first cable (e.g., an extension cable 5210 and a bending cable 5220). In addition, the plurality of active pulleys 5100 may be connected with the tension member 2120 through the at least one first cable (e.g., the extension cable 5210 and the bending cable 5220).

The at least one first cable may include an extension cable 5210 and a bending cable 5220.

The at least one first cable may include an extension cable 5210 and a bending cable 5220.

Here, when the at least one first cable is formed as a single cable, the extension cable 5210 and the bending cable 5220 may refer to the same cable while being functionally distinguished.

Specifically, when the actuator 2010 rotates in a direction in which each joint of the finger 2000 is extended, a total length of the extension cable 5210 may decrease, and a total length of the bending cable 5220 may increase by a length corresponding to (e.g., equal to) the decrease in the total length of the extension cable 5210.

Conversely, when the actuator 2010 rotates in a direction in which each joint of the finger 2000 is bent, a total length of the bending cable 5220 may decrease, and a total length of the extension cable 5210 may increase by a length corresponding to (e.g., equal to) the decrease in the total length of the bending cable 5220.

Here, the extension cable 5210 may be wound around an outer circumferential surface of each of the plurality of active pulleys 5100 in a first direction. The bending cable 5220 may be wound around the outer circumferential surface of each of the plurality of active pulleys 5100 in the same direction (e.g., the first direction).

For example, in a case of the finger 2000 of the right hand (e.g., the hand 1000), when viewed based on a state in which a direction in which the finger 2000 extends is toward a left side, the extension cable 5210 may be wound in a clockwise direction about a rotation axis of the active drive pulley 2020 coupled to the actuator 2010 at each of the plurality of active pulleys 5100. In the case of the finger 2000 of the right hand (e.g., the hand 1000), when viewed based on a state in which the direction in which the finger 2000 extends is toward the left side, the bending cable 5220 may be wound in a clockwise direction, which is the same direction as a winding direction of the extension cable 5210, about the rotation axis of the active drive pulley 2020 coupled to the actuator 2010 at each of the plurality of active pulleys 5100. In this case, the clockwise direction may be defined as a direction in which the at least one first cable is wound around the plurality of active pulleys 5100 starting from an end of the extension cable 5210 positioned at a side of the tension member 2120.

According to some embodiments, in the case of the finger 2000 of the right hand (e.g., the hand 1000), when viewed based on a state in which the extending direction of the finger 2000 is toward a left side, the extension cable 5210 and the bending cable 5220 may both be wound in a counterclockwise direction about a rotation axis of the active drive pulley 2020 coupled to the actuator 2010 at each of the plurality of active pulleys 5100. In this case, the counterclockwise direction may be defined as a direction in which at least one first cable is wound around the plurality of active pulleys 5100, starting from an end of the bending cable 5220 positioned at a side of the tension member 2120.

When the actuator 2010 rotates in a first direction to extend the finger 2000, a total length of the extension cable 5210 may decrease. In this case, since a total length of the at least one first cable remains the same, a total length of the bending cable 5220 may be increased by a length corresponding to (e.g., equal to) the decrease in the total length of the extension cable 5210.

In contrast, when the actuator 2010 rotates in a second direction opposite to the first direction to bend the finger 2000, a total length of the bending cable 5220 may decrease. In this case, since a total length of the at least one first cable remains the same, a total length of the extension cable 5210 may be increased by a length corresponding to (e.g., equal to) the decrease in the total length of the bending cable 5220.

Specifically, when the actuator 2010 rotates, the active drive pulley 2020 coupled to the actuator 2010 may rotate. Due to the rotation of the active drive pulley 2020, the at least one first cable may move. Accordingly, since a total length of at least one first cable remains the same, the extension cable 5210 and the bending cable 5220 may increase or decrease in length in a complementary manner with respect to each other.

Specifically, when each joint of the finger 2000 is extended, a length of the extension cable 5210 wound around each of the plurality of active pulleys 5100 may decrease. For example, when the finger 2000 is in a bent state, the extension cable 5210 may be further wound around the plurality of active pulleys 5100 by an amount corresponding to a bent angle. When the finger 2000 is extended, the extension cable 5210 wound by an amount corresponding to an extending angle may be unwound. Accordingly, the total length of the extension cable 5210 may decrease.

In this case, since the total length of at least one first cable 5200 is identical, the total length of the bending cable 5220 may be increased by a length corresponding to the decrease in the total length of the extension cable 5210.

In contrast, when each joint of the finger 2000 is bent, a total length of the bending cable 5220 wound around each of the plurality of active pulleys 5100 may decrease. For example, when the finger 2000 is bent, as the bending cable 5220 is pulled, the total length of the bending cable 5220 may decrease. At the same time, the total length of the extension cable 5210 may increase. Specifically, as the bending cable 5220 is pulled, the extension cable 5210 may be additionally wound around each of the plurality of active pulleys 5100 by an amount corresponding to an angle by which the finger 2000 is bent. Accordingly, the total length of the extension cable 5210 may increase. At the same time, since the total length of at least one first cable remains the same, the total length of the bending cable 5220 may decrease.

In other words, by driving one actuator 2010, a length of at least one first cable is adjusted, thereby enabling each joint of the finger 2000 to be driven.

Accordingly, the finger 2000 may grasp an object due to driving of one actuator 2010. In other words, the finger 2000 may grip the object in a manner of enclosing the object due to driving of one actuator 2010.

At least one first cable may be connected to the tension member 2120. The tension member 2120 may apply tension to the at least one first cable. Accordingly, when the at least one first cable connected to the plurality of active pulleys 5100 rotates according to driving of the actuator 2010, the tension member 2120 may perform a role of maintaining the at least one first cable such that the at least one first cable is not separated from the plurality of active pulleys 5100.

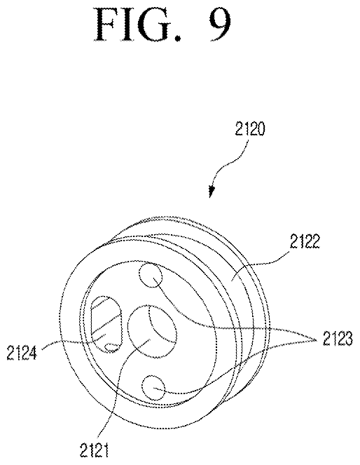

Specifically, as shown in FIG. 6, an end of the bending cable 5220 among the at least one first cable may be fixed to an end of the first frame 2100, and an end of the extension cable 5210 among the at least one first cable may be fixed to the tension member 2120. In this state, the tension member 2120 may be rotated and fixed through a plurality of second holes (e.g., second holes 2123 of FIG. 9) formed on a side surface, and through this, tension may be applied to the at least one first cable.

Accordingly, when at least one first cable is elongated as the finger 2000 performs repeated operations, tension may be applied again to the at least one first cable by rotating the tension member 2120 in a direction in which the at least one first cable becomes taut.

However, embodiments of the present disclosure are not limited thereto, and, contrary to FIG. 6, an end of the extension cable 5210 among at least one first cable may be fixed to an end of the first frame 2100, and an end of the bending cable 5220 among the at least one first cable may be fixed to the tension member 2120.

In addition, an operation of rotating the tension member 2120 through the plurality of second holes (e.g., second holes 2123 of FIG. 9) may be manually performed by a user using an external bolt. In addition, the tension member 2120 may be provided with a motor and a sensor for sensing tension to be configured such that a degree of tension is sensed through the sensor and the tension member 2120 is rotated using the motor to maintain appropriate tension.

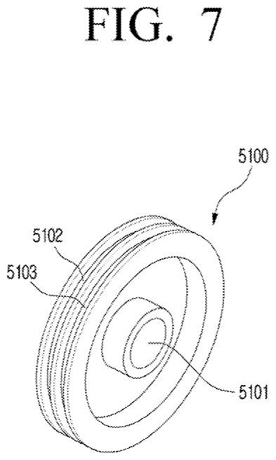

FIG. 7 is a diagram illustrating a structure of the plurality of active pulleys 5100 according to at least one example embodiment of the present disclosure.

With reference to FIG. 7, each of the plurality of active pulleys 5100 may include a hole 5101 for being connected to each of the plurality of shafts.

With reference to FIG. 7, each of the plurality of active pulleys 5100 may include an extension slot 5102 and a bending slot 5103 that are disposed parallel to each other at the outer circumferential surfaces thereof. For example, the extension slot 5102 and the bending slot 5103 may extend parallel to each other around the active pulley 5100.

Although FIG. 7 illustrates that the extension slot 5102 and the bending slot 5103 are formed in each of the plurality of active pulleys 5100, embodiments of the present disclosure are not limited thereto. For example, each of the plurality of active pulleys 5100 may be configured in a form in which an active pulley around which the extension cable 5210 is wound and an active pulley around which the bending cable 5220 is wound are arranged in parallel with each other.

In addition, each of the plurality of active pulleys 5100 may be configured such that the extension slot 5102 and the bending slot 5103 are not distinguished and only one slot is formed. In this case, each of the plurality of active pulleys 5100 may be configured such that the extension cable 5210 and the bending cable 5220 are wound together within one slot.

The extension slot 5102 and the bending slot 5103 may be formed to have the same depth in an outer circumferential surface of each of the plurality of active pulleys 5100. However, embodiments of the present disclosure are not limited thereto, and the extension slot 5102 and the bending slot 5103 may be formed to have different depths in the outer circumferential surface of each of the plurality of active pulleys 5100.

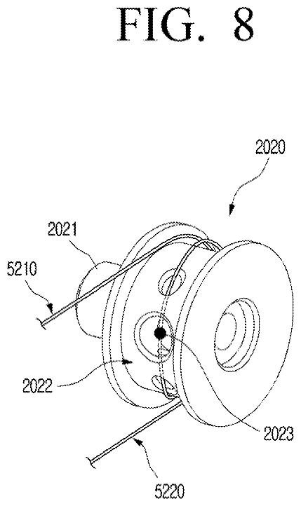

The extension slot 5102 may be configured such that, among at least one first cable, the extension cable 5210 is wound in a first direction. The bending slot 5103 may be configured such that, among the at least one first cable, the bending cable 5220 is wound in the first direction. For example, in the case of the finger 2000 of the right hand, when viewed based on a state in which a direction in which the finger 2000 extends is toward the left side, the extension cable 5210 and the bending cable 5220 may both be wound in a clockwise direction about a rotation axis of the active drive pulley 2020 coupled to the actuator 2010 at each of the plurality of active pulleys 5100. In this case, the clockwise direction may be defined as a direction in which the at least one first cable is wound around the plurality of active pulleys 5100, starting from an end of the extension cable 5210 positioned at a side of the tension member 2120. FIG. 8 is a diagram illustrating a structure of the active drive pulley 2020 coupled to the actuators 2010 according to at least one example embodiment of the present disclosure.

With reference to FIG. 8, the active drive pulley 2020 may be at one end of the actuator 2010. Accordingly, the active drive pulley 2020 may rotate by receiving power of the actuator 2010.

The active drive pulley 2020 may include a coupling part 2021, a first slot 2022, and a first cable connecting groove 2023.

The coupling part 2021 may be a configuration coupleable with the actuator 2010. The coupling part 2021 may be coupled with the actuator 2010 in various methods.

The first slot 2022 may be disposed on an outer circumferential surface of the active drive pulley 2020. The at least one first cable (e.g., the extension cable 5210 and the bending cable 5220) may be wound in the first slot 2022.

The extension cable 5210 and the bending cable 5220 may be connected with each other at the first cable connecting groove 2023 of the active drive pulley 2020.

A connection method of the extension cable 5210 and the bending cable 5220 may be connected using various methods such as a binding method using a knotting method, a bonding method, and a welding method.

However, when the extension cable 5210 and the bending cable 5220 of at least one first cable are integrally formed, the at least one first cable may be formed in a state of being wound on an outer circumferential surface of a first slot 2022 of the active drive pulley 2020.

In addition, the at least one first cable may be configured such that, after being wound on the outer circumferential surface of the first slot 2022 of the active drive pulley 2020, the at least one first cable is fitted into the first cable connecting groove 2023 to prevent separation.

FIG. 9 is a diagram illustrating the tension member 2120 according to at least one example embodiment of the present disclosure.

With reference to FIG. 9, the tension member 2120 may include a first hole 2121, a second slot 2122, and a plurality of second holes 2123.

The tension member 2120 may be configured to apply tension to the at least one first cable (e.g., the extension cable 5210 and the bending cable 5220) for the at least one first cable (e.g., the extension cable 5210 and the bending cable 5220) from being deviated from the plurality of active pulleys 5100 when the at least one first cable (e.g., the extension cable 5210 and the bending cable 5220) connected to the plurality of active pulleys 5100 rotates according to driving of the actuator 2010.

The tension member 2120 may include the first hole 2121 at a center part thereof. The first hole 2121 may be configured to couple with the first frame 2100 among the plurality of frames. The tension member 2120 may be connected to the first frame 2100 among the plurality of frames through the first hole 2121. The tension member 2120 may maintain a fixed state when an external force equal to or greater than a preset level in a rotational direction is not applied in a state in which the first hole 2121 is coupled to the first frame 2100. Accordingly, the tension member 2120 may prevent tension applied to the at least one first cable from being arbitrarily changed. In addition, when the at least one first cable is elongated due to repeated operation of the finger 2000, a user may manually rotate the tension member 2120 to adjust the tension.

In addition, a tension state of the at least one first cable may be sensed through a sensor, and by applying an external force equal to or greater than a preset level to the tension member 2120 using a motor to rotate the tension member 2120, the tension member 2120 may be configured to automatically maintain an appropriate tension.

The second slot 2122 may be a configuration with which the at least one first cable (e.g., the extension cable 5210 and the bending cable 5220) can be wound. The second slot 2122 may be disposed on an outer circumferential surface of the tension member 2120.

The plurality of second holes 2123 may be configured to rotate the tension member 2120. The plurality of second holes 2123 may be formed to allow a user to insert an external bolt. The plurality of second holes 2123 may allow the user to insert an external bolt and rotate the tension member 2120, thereby adjusting tension of the at least one first cable.

According to some embodiments, when a sensor and a motor are provided, the plurality of second holes 2123 may not be formed, and the motor may be coupled to a shaft connected to an inner circumferential surface of the first hole 2121. In addition, the sensor may be disposed in the tension member 2120 so as to detect tension applied to the at least one first cable. Accordingly, the robot apparatus 1 may, based on a tension value detected through the sensor, control the motor to rotate the shaft to rotate the tension member 2120, such that the tension of the at least one first cable is maintained within a set range.

The third hole 2124 may be configured to fix one end of the at least one first cable. The at least one first cable may be fixed in a tied state to the third hole 2124.

Accordingly, even if the tension member 2120 applies tension to the at least one first cable (e.g., the extension cable 5210 and the bending cable 5220), the at least one first cable (e.g., the extension cable 5210 and the bending cable 5220) may not be deviated from the tension member 2120.

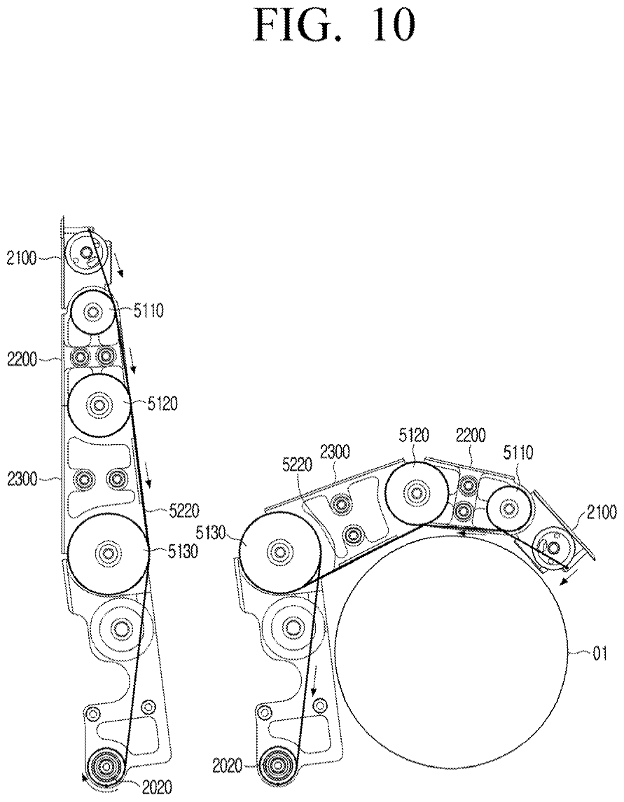

FIG. 10 is a diagram illustrating a grasping operation based on the bending cable 5220 among at least one first cable according to at least one example embodiment of the present disclosure.

Referring to FIG. 10, the finger 2000 may include the first active pulley 5110, the second active pulley 5120, the third active pulley 5130, the active drive pulley 2020, and the bending cable 5220.

With respect to a left hand, when the finger 2000 is viewed from a left side in a state in which a palm faces right (see FIG. 10), the bending cable 5220 may be sequentially wound in a clockwise direction around each of the first active pulley 5110, the second active pulley 5120, and the third active pulley 5130. In addition, the bending cable 5220 may be disposed in a direction towards a palm surface with respect to a center line of each of the first active pulley 5110, the second active pulley 5120, and the third active pulley 5130.

In FIG. 10, with respect to a left hand, when the finger 2000 is viewed from a left side in a state in which the palm faces right, if the active drive pulley 2020 is rotated in a clockwise direction by an actuator, a total length of the bending cable 5220 may decrease.

Specifically, since a total length of the at least one first cable 5200 is maintained constant, as the length of the bending cable 5220 decrease by rotation of the plurality of active drive pulleys 2020, a length of the extension cable 5210 may be relatively increased.

Accordingly, the bending cable 5220 pulls the first frame 2100, the second frame 2200, and the third frame 2300 based on the first active pulley 5110, the second active pulley 5120, and the third active pulley 5130, respectively, and accordingly, respective joints of the finger 2000 may be sequentially bent.

Accordingly, the finger 2000 may grasp an object O1 by contacting the object O1 in a form of surrounding the object O1 through the sequential joint bending as described above.

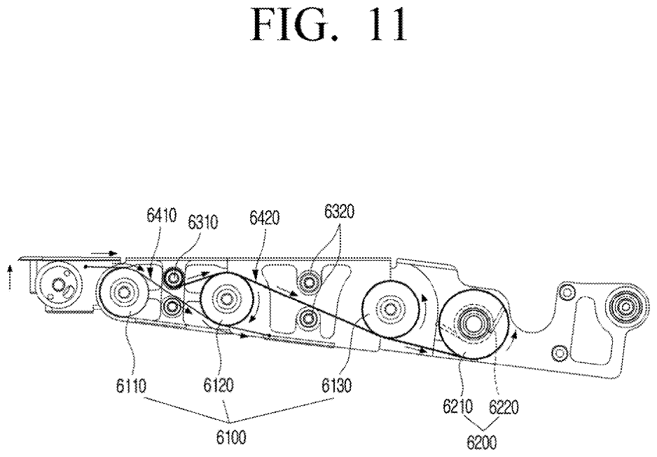

FIG. 11 is a diagram illustrating a coupling relationship of a plurality of passive pulleys 6100 among a structure of the finger 2000 according to at least one example embodiment of the present disclosure.

In FIG. 11, the finger 2000 may include the plurality of passive pulleys 6100, a plurality of first fixing parts 6310 and 6320, a plurality of second cables (e.g., an oblique retinacular ligament (ORL) cable 6410 and a lumbrical muscle (LUM) cable 6420), and the spring module 6200.

In FIG. 11, the plurality of passive pulleys 6100 may be disposed on each of a plurality of shafts. Passive pulleys adjacent to each other among the plurality of passive pulleys 6100 may be connected to each other in a state in which each of the plurality of second cables are wound thereon. Accordingly, when an external force is applied to any one of the joints of the finger 2000, the external force may be transmitted to another joint through the plurality of second cables.

The plurality of passive pulleys 6100 may include the first passive pulley 6110 connected to the first shaft 2210 positioned at the distal interphalangeal (DIP) joint among the plurality of shafts.

The plurality of passive pulleys 6100 may include the second passive pulley 6120 connected to the second shaft 2310 positioned at the proximal interphalangeal (PIP) joint among the plurality of shafts.

The plurality of passive pulleys 6100 may include the third passive pulley 6130 connected to the third shaft 2410 positioned at the metacarpophalangeal (MCP) joint among the plurality of shafts.

Each of the plurality of passive pulleys 6100 may be disposed in parallel on the plurality of shafts with each of the plurality of active pulleys 5100. In other words, each of the plurality of passive pulleys 6100 may be on the respective shafts, and may be disposed in parallel with each of the active pulleys 5100 that is also on the respective one of the shafts.

The plurality of first fixing parts 6310, 6320 may be configured to fix each of the plurality of frames. In addition, the plurality of first fixing parts 6310, 6320 may also fix the plurality of second cables.

In FIG. 11, in the finger 2000 of the right hand (e.g., the hand 1000), when viewed based on a state in which a direction in which the finger 2000 extends is toward a left side, among the plurality of second cables, an ORL cable 6410 may be disposed to extend along an upper side of an outer circumferential surface of the first passive pulley 6110 and a lower side of an outer circumferential surface of the second passive pulley 6120. For example, as illustrated in FIG. 11, in the case of the finger 2000 of the right hand (e.g., the hand 1000), when viewed based on a state in which the direction in which the finger 2000 extends is toward the left side, the ORL cable 6410 may be disposed to extend along an upper surface of the outer circumferential surface of the first passive pulley 6110 starting from a point connected to the first frame 2100, and to extend along a lower surface of the outer circumferential surface of the second passive pulley 6120. In addition, the ORL cable 6410 may be fixed to a lower end of the second frame 2200.

In the finger 2000 of the right hand (e.g., the hand 1000), when viewed based on a state in which the direction in which the finger 2000 extends is toward the left side, among the plurality of second cables, the LUM cable 6420 may be sequentially wound in opposite directions at the second passive pulley 6120 and the third passive pulley 6130.

For example, as illustrated in FIG. 11, in the case of the finger 2000 of the right hand (e.g., the hand 1000), when viewed based on a state in which the direction in which the finger 2000 extends is toward the left side, the LUM cable 6420 may be sequentially wound around the plurality of passive pulleys 6100 starting from a point fixed to a first-first fixing part (e.g., the first fixing part 6310) connected to the second frame 2200 among the plurality of first fixing parts 6310, 6320, and at this time, may be wound in a clockwise direction at the second passive pulley 6120 and in a counterclockwise direction at the third passive pulley 6130. In addition, the LUM cable 6420 may be wound around the spring module 6200.

Among the plurality of second cables, the ORL cable 6410, when an external force is applied in a direction in which the finger 2000 is bent, may move along the second passive pulley 6120 among the passive pulleys 6100 and increase in tension. Accordingly, the tension is transmitted to the first frame 2100 through the first passive pulley 6110, thereby inducing an interlocking operation in which the first frame 2100 coupled to the first passive pulley 6110 corresponding to a Distal Interphalangeal Joint (DIP join) is extended in response to flexion of the second passive pulley 6120 corresponding to a Proximal Interphalangeal Joint (PIP joint).

Accordingly, the ORL cable 6410 may transmit tension generated in response to flexion of the PIP joint to the DIP joint through the first passive pulley 6110 and the second passive pulley 6120, and induces extension of the DIP joint, thereby enabling the finger 2000 to stably perform a pinching operation for grasping an object.

Among the plurality of second cables, the LUM cable 6420 may be a cable for inducing passive driving of the finger 2000, and may be disposed along the plurality of passive pulleys 6100. Specifically, in the finger 2000 of the right hand (e.g., the hand 1000), when viewed based on a state in which a direction in which the finger 2000 extends is toward a left side, starting from a point fixed to the first-first fixing part (e.g., the first fixing part 6310), the LUM cable 6420 may be wound in a clockwise direction around the second passive pulley 6120 corresponding to a PIP joint, wound in a counterclockwise direction around the third passive pulley 6130 corresponding to an MCP joint, and wound in a counterclockwise direction around the spring module 6200.

At this time, when an external force is applied in a direction in which the finger 2000 is bent, the LUM cable 6420 transmits tension generated by the external force through the plurality of passive pulleys 6100 to generate a flexion moment at the third passive pulley 6130 corresponding to the MCP joint and an extension moment at the second passive pulley 6120 corresponding to the PIP joint, respectively. Accordingly, during a process in which the finger 2000 pinches an object, while the finger 2000 bends about the third passive pulley 6130 corresponding to the MCP joint, excessive flexion of the second passive pulley 6120 corresponding to the PIP joint may be suppressed.

In addition, the LUM cable 6420 may be provided with an initial tension by a torsion spring 6220 included in the spring module 6200, and a posture of the finger 2000 may be stably maintained by a restoring force of the torsion spring 6220. In addition, when the external force is removed, the LUM cable 6420 may induce the finger 2000 to be restored to an original state by the spring module 6200.

Accordingly, the LUM cable 6420 may stably perform the pinching operation.

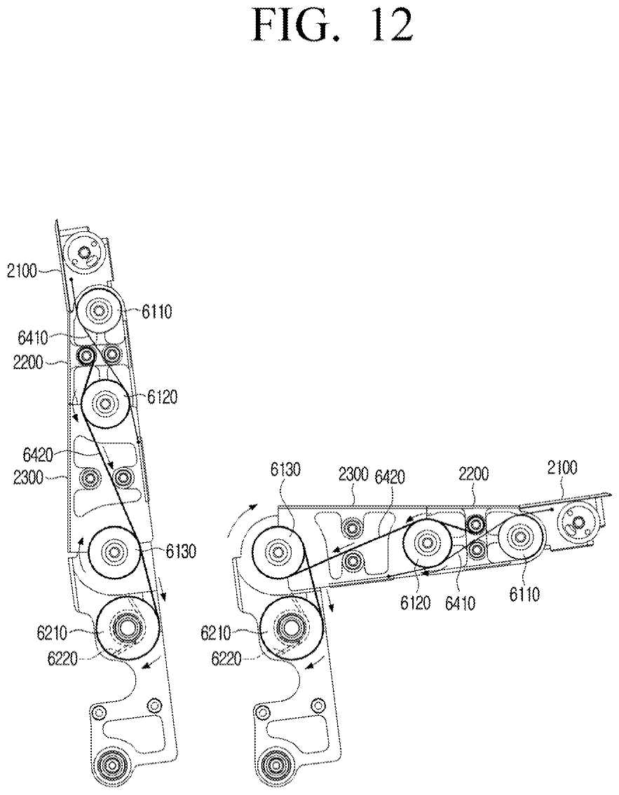

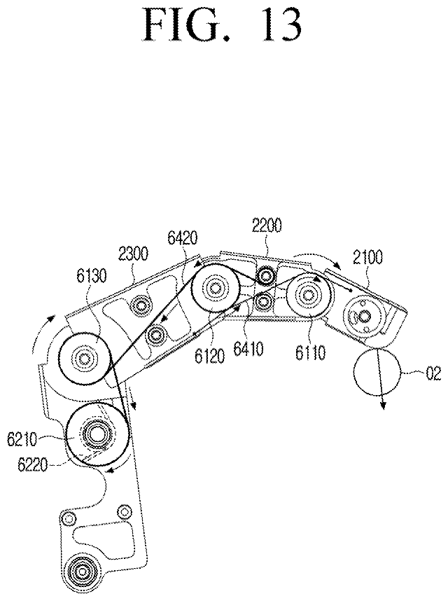

A detailed description of an operation related thereto will be described below with reference to FIG. 12 and FIG. 13. With reference to FIG. 11, the finger 2000 may include the spring module 6200.

The spring module 6200 may be configured to restore a position of the rotated plurality of passive pulleys 6100 when the external force applied to the plurality of frames is removed.

The spring module 6200 may be disposed at one side of the plurality of passive pulleys 6100. The spring module 6200 may be disposed at a side of the third passive pulley 6130 that faces away from the second passive pulley 6120. For example, the third passive pulley 6130 may be between the second passive pulley 6120 and the spring module 6200.

The spring module 6200 may include the passive drive pulley 6210 and the torsion spring 6220.

The passive drive pulley 6210 may be connected to the torsion spring 6220, and may transmit a restoring force of the torsion spring 6220 to the plurality of passive pulleys 6100 through the plurality of second cables. The passive drive pulley 6210 may be disposed on the same line as the plurality of passive pulleys 6100. However, embodiments of the present disclosure are not limited thereto, and the passive drive pulley 6210 may be disposed at a position spaced apart by a predetermined distance from the plurality of passive pulleys 6100 or may be disposed on different planes instead of being disposed on the same line. Even in this case, the restoring force of the torsion spring 6220 may be transmitted to the plurality of passive pulleys 6100 through the plurality of second cables.

The LUM cable 6420 among the plurality of second cables may be wound around the passive drive pulley 6210.

FIG. 12 is a diagram illustrating an operation of the finger 2000 by the LUM cable 6420 according to at least one example embodiment of the present disclosure.

Referring to FIG. 12, the finger 2000 may include the passive drive pulley 6210 and the torsion spring 6220.

Tension may be formed in the LUM cable 6420 by the passive drive pulley 6210 and the torsion spring 6220. Here, the tension may be transmitted along the third passive pulley 6130 and the second passive pulley 6120.

Specifically, the tension formed in the LUM cable 6420 may apply a pulling force to the third frame 2300 based on the third passive pulley 6130, thereby generating a moment for rotating an MCP joint in a flexion direction. In addition, the same tension may act on the second frame 2200 based on the second passive pulley 6120 to limit flexion of a PIP joint or to generate a moment in an extension direction.

At this time, a magnitude and a direction of the moment acting on each joint may be determined by a path of the LUM cable 6420 and an arrangement of the passive pulleys 6100.

Accordingly, the third frame 2300 corresponding to the MCP joint of the finger 2000 rotates in the flexion direction, and the second frame 2200 corresponding to the PIP joint may be prevented from excessive flexion by the LUM cable 6420 and may be induced in the extension direction.

Accordingly, respective joints of the finger 2000 may be interlocked with each other to form a stable pinching posture.

FIG. 13 is a diagram illustrating a force acting on the finger 2000 by the LUM cable 6420 according to at least one example embodiment of the present disclosure.

Referring to FIG. 13, tension formed in the LUM cable 6420 may be generated by the passive drive pulley 6210 and the torsion spring 6220. Here, the generated tension may be transmitted along the third passive pulley 6130 and the second passive pulley 6120.

The transmitted tension may act on the third frame 2300 based on the third passive pulley 6130 to generate a moment in a flexion direction with respect to an MCP joint.

In addition, the same tension may act on the second frame 2200 based on the second passive pulley 6120 to suppress flexion of a PIP joint or to generate a moment in an extension direction.

Meanwhile, according to rotation of the second passive pulley 6120, the ORL cable 6410 may move along the second passive pulley 6120 corresponding to a rotation direction of the second passive pulley 6120.

Accordingly, tension may be formed in the ORL cable 6410, and the formed tension may be transmitted through the first passive pulley 6110 to act on the first frame 2100 corresponding to a DIP joint.

Accordingly, the DIP joint may be interlocked with an operation of the PIP joint, and may be induced in a flexion direction.

In other words, a force in a direction toward an object O2 may be formed at an end of the finger 2000 by interaction between the LUM cable 6420 and the ORL cable 6410.

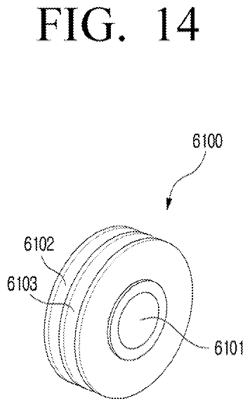

Accordingly, the finger 2000 may be aligned such that a direction of force is toward a center of the object O2, and may perform a pinching operation capable of stably grasping the object O2. FIG. 14 is a diagram illustrating a structure of the second passive pulley 6120 among the plurality of passive pulleys 6100 according to at least one example embodiment of the present disclosure.

In FIG. 14, among the plurality of passive pulleys 6100, the second passive pulley 6120 may include a third hole 6101, an ORL slot 6102 to which the ORL cable 6410 is connected, and a LUM slot 6103 to which the LUM cable 6420 is connected.

Unlike FIG. 14, among the plurality of passive pulleys 6100, the first passive pulley 6110 may be formed to include only the ORL slot 6102 with which the ORL cable 6410 is connected. In addition, among the plurality of passive pulleys 6100, the third passive pulley 6130 may be formed to include only the LUM slot 6103 in which the LUM cable 6420 is wound.

The third hole 6101 may be configured to be connected to each of the plurality of shafts. The third holes 6101 of the plurality of passive pulleys 6100 may accommodate the plurality of shafts, respectively.

The ORL slot 6102 and the LUM slot 6103 may be disposed parallel to each other at the outer circumferential surfaces of each of the plurality of passive pulleys 6100. In other words, the ORL slot 6102 and the LUM slot 6103 may be disposed parallel to each other.

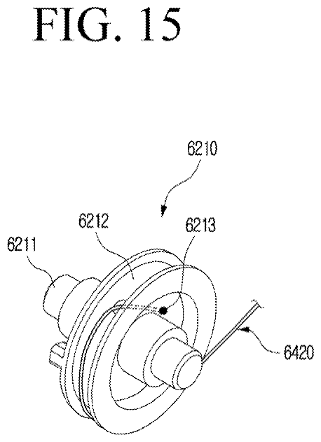

The ORL slot 6102 may be configured such that the ORL cable 6410 among the plurality of second cables is in the ORL slot 6102. The LUM slot 6103 may be configured such that the LUM cable 6420 among the plurality of second cables is wound therearound. FIG. 15 is a diagram illustrating a structure of the passive drive pulley 6210 according to at least one example embodiment of the present disclosure.

In FIG. 15, the passive drive pulley 6210 may include a coupling part 6211, a fourth slot 6212, and a second fixing part 6213. The torsion spring 6220 may be coupled to the coupling part 6211. Accordingly, the passive drive pulley 6210 may transmit an elastic force of the torsion spring 6220 to the plurality of passive pulleys 6100 through the plurality of second cables. Accordingly, the finger 2000 may stably support the plurality of frames by external force.

The fourth slot 6212 may be configured such that the LUM cable 6420 among the plurality of second cables is wound therearound.

The second fixing part 6213 may be configured to fix the LUM cable 6420 wound in the fourth slot 6212 from being deviated from the passive drive pulley 6210.

In FIG. 15, the passive drive pulley 6210 rotates to wind or unwind the LUM cable 6420, and a rotational force may be applied thereto by a restoring force of the torsion spring 6220. Accordingly, the passive drive pulley 6210 may form tension in the LUM cable 6420, and the tension may be transmitted through the plurality of passive pulleys 6100 to provide a passive driving force to joints of the finger 2000.

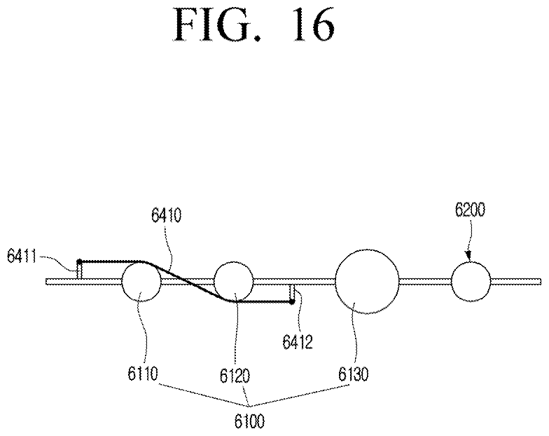

FIG. 16 is a diagram illustrating a coupling relationship of a passive pulley 6100 among a structure of the finger 2000 according to at least one example embodiment of the present disclosure.

In FIG. 16, the finger 2000 may include the plurality of passive pulleys 6100, the spring module 6200, and a plurality of third fixing parts 6411 and 6412.

The plurality of third fixing parts 6411 and 6412 may be configured to fix the ORL cable 6410 among the plurality of second cables.

One among the plurality of third fixing parts 6411 and 6412 may be disposed at a top side of the line of the plurality of passive pulleys 6100. The other one among the plurality of third fixing parts 6411 and 6412 may be disposed at a bottom side of the line of the plurality of passive pulleys 6100.

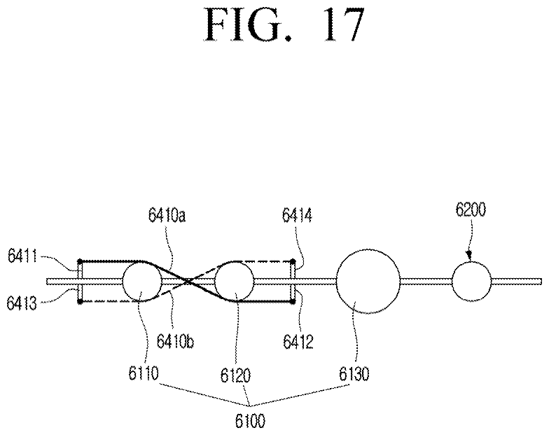

Accordingly, the ORL cable 6410 may connect the first passive pulley 6110 and the second passive pulley 6120 in an oblique direction. In other words, in the right hand (e.g., the hand 1000), when viewed in a state in which a direction in which the finger 2000 extends is toward the left side, the ORL cable 6410 may be in contact with an upper surface of an outer circumferential surface of the first passive pulley 6110, and may be in contact with a lower surface of an outer circumferential surface of the second passive pulley 6120. FIG. 17 is a diagram illustrating a coupling relationship of the passive pulley 6100 among a structure of the finger 2000 according to at least one example embodiment of the present disclosure.

With reference to FIG. 17, the finger 2000 may include the plurality of passive pulleys 6100, the spring module 6200, the plurality of third fixing parts 6411 and 6412, and a plurality of fourth fixing parts 6413 and 6414.

The plurality of third fixing parts 6411 and 6412 and the plurality of fourth fixing parts 6413 and 6414 may respectively be configured to fix a first ORL cable 6410a and a second ORL cable 6410b among the ORL cables 6410.

In the right hand (e.g., the hand 1000), when viewed in a state in which a direction in which the finger 2000 extends is toward the left side, a first-third fixing part (e.g., the third fixing part 6411) among the plurality of third fixing parts may be disposed above a centerline of the plurality of passive pulleys 6100. A second-third fixing part (e.g., the third fixing part 6412) among the plurality of third fixing parts may be disposed below the centerline of the plurality of passive pulleys 6100.

Accordingly, a first ORL cable 6410a may connect the first passive pulley 6110 and the second passive pulley 6120 in an oblique direction. In other words, in the right hand (e.g., the hand 1000), when viewed in a state in which a direction in which the finger 2000 extends is toward the left side, the first ORL cable 6410a may be connected to an upper side of an outer circumferential surface of the first passive pulley 6110, and may be connected to a lower side of an outer circumferential surface of the second passive pulley 6120.

A first-fourth fixing part (e.g., the fourth fixing part 6413) among the plurality of fourth fixing parts may be disposed below the centerline of the plurality of passive pulleys 6100. A second-fourth fixing part (e.g., the fourth fixing part 6414) among the plurality of fourth fixing parts may be disposed above the centerline of the plurality of passive pulleys 6100.

In other words, in the right hand (e.g., the hand 1000), when viewed in a state in which a direction in which the finger 2000 extends is toward the left side, the plurality of fourth fixing parts 6413 and 6414 may be formed symmetrically to the plurality of third fixing parts 6411 and 6412 with respect to the centerline of the plurality of passive pulleys 6100.

Accordingly, a second ORL cable 6410b may connect the first passive pulley 6110 and the second passive pulley 6120 in an oblique direction. In other words, in the right hand (e.g., the hand 1000), when viewed in a state in which a direction in which the finger 2000 extends is toward the left side, the second ORL cable 6410b may be connected to a lower side of an outer circumferential surface of the first passive pulley 6110, and may be connected to an upper side of an outer circumferential surface of the second passive pulley 6120.

Here, when both the first ORL cable 6410a and the second ORL cable 6410b are formed of a non-elastic material, the first passive pulley 6110 corresponding to a distal interphalangeal joint (DIP joint) and the second passive pulley 6120 corresponding to a proximal interphalangeal joint (PIP joint) may be mechanically coupled to move at a preset ratio.

Alternatively, when the first ORL cable 6410a is formed of a non-elastic material and the second ORL cable 6410b is formed of an elastic material, in a state in which no external force is applied to the finger, the first passive pulley 6110 corresponding to the DIP joint and the second passive pulley 6120 corresponding to the PIP joint may be mechanically coupled to move at a preset ratio.

On the other hand, when an external force is applied, as the second ORL cable 6410b formed of the elastic material is elastically deformed, an angular range deviating from the preset ratio may be allowed. Thereafter, when the external force is removed, the first passive pulley 6110 corresponding to the DIP and the second passive pulley 6120 corresponding to the PIP may return to angles corresponding to the preset ratio by a restoring force of the second ORL cable 6410b.

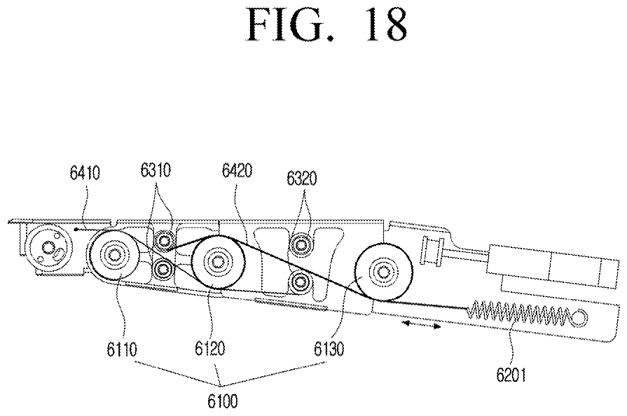

FIG. 18 is a diagram illustrating a coupling relationship of the passive pulley 6100 among a structure of the finger 2000 according to at least one example embodiment of the present disclosure.

With reference to FIG. 18, a structure of the passive pulley 6100, the plurality of second cables, and the plurality of first fixing parts 6310 and 6320 of the finger 2000 is the same as that in FIG. 11, and thus a repeated description thereof may be omitted.

With reference to FIG. 18, the finger 2000 may include a tension spring 6201. The finger 2000 may substitute the spring module 6200 in FIG. 11 with the tension spring 6201.

The tension spring 6201 may be connected to one end of the LUM cable 6420. According to an operation as described with reference to FIG. 10, when an external force is applied to the finger 2000, as the LUM cable 6420 is pulled or relaxed, a tensile force or a restoring force of the tension spring 6201 may be transmitted. Accordingly, the tension spring 6201 may be extended or contracted.

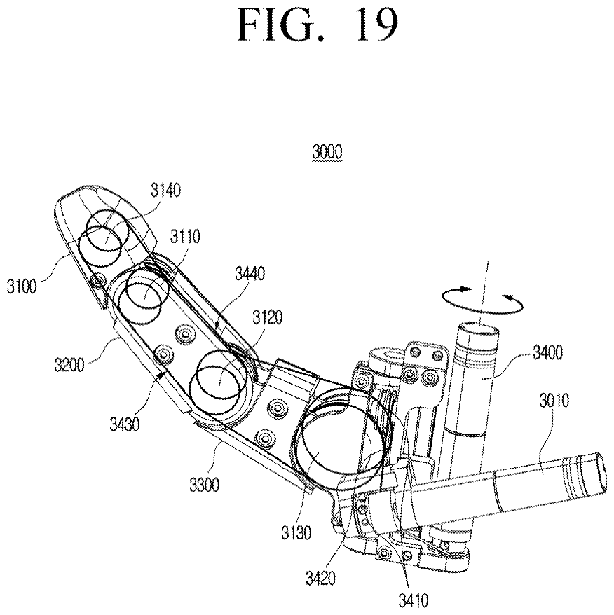

FIG. 19 is a diagram illustrating a coupling relationship of thumb active pulleys (e.g., a first thumb active pulley 3110, a second thumb active pulley 3120, and a third thumb active pulley 3130) among a structure of the thumb module 3000 according to at least one example embodiment of the present disclosure.

The thumb module 3000 may include a plurality of thumb frames. The plurality of thumb frames may include a first thumb frame 3100, a second thumb frame 3200, and a third thumb frame 3300.

The first thumb frame 3100 may include a thumb tension member 3140 (e.g., a thumb tensioner) inside thereof. The thumb tension member 3140 may be configured to apply tension to at least one third cable (e.g., a thumb extension cable 3430 and a thumb bending cable 3440).

The plurality of thumb active pulleys (e.g., the first thumb active pulley 3110, the second thumb active pulley 3120, and the third thumb active pulley 3130) may be disposed at positions at which each of the plurality of thumb frames is connected.

A first thumb active pulley 3110 may be disposed at a position at which the first thumb frame 3100 and the second thumb frame 3200 are connected. A second thumb active pulley 3120 may be disposed at a position at which the second thumb frame 3200 and the third thumb frame 3300 are connected. A third thumb active pulley 3130 may be disposed at a position at which the third thumb frame 3300 and a rotation actuator 3400 are connected.

The at least one third cable may include a thumb extension cable 3430 and a thumb bending cable 3440.

The thumb extension cable 3430 and the thumb bending cable 3440 may have a structure coupled to the plurality of thumb active pulleys (e.g., the first thumb active pulley 3110, the second thumb active pulley 3120, and the third thumb active pulley 3130) that is the same as or similar to a connection structure of the finger 2000 shown in FIG. 6.

In other words, in the left hand, based on viewing a left side of a thumb in a state in which a palm faces toward the right side, and based on the thumb extension cable 3430 being wound on the first thumb frame 3100, the thumb extension cable 3430 and the thumb bending cable 3440 may be sequentially wound in a counterclockwise direction on each of the plurality of thumb active pulleys (e.g., the first thumb active pulley 3110, the second thumb active pulley 3120, and the third thumb active pulley 3130. The rotation actuator 3400 may be disposed at one side of the plurality of thumb frames. The rotation actuator 3400 may be configured to rotate the thumb module 3000 in a direction perpendicular to the bottom surface of the palm module 4000.

The thumb module 3000 may include a thumb actuator 3010. The thumb actuator 3010 may be configured to drive each joint of the thumb module 3000 by being connected with the at least one third cable (e.g., the thumb extension cable 3430 and the thumb bending cable 3440).

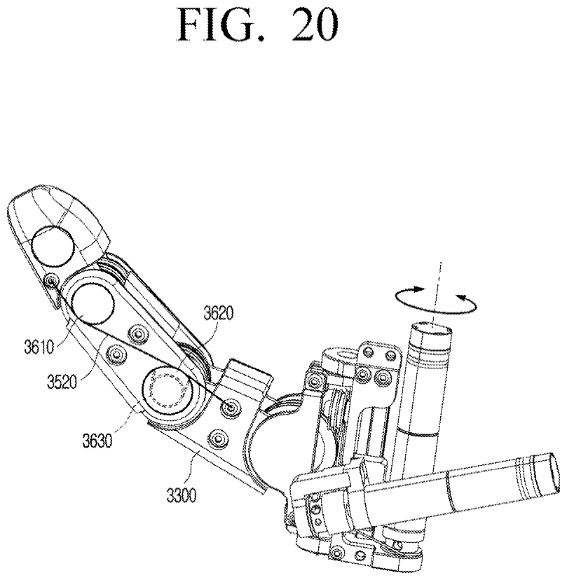

FIG. 20 is a diagram illustrating a coupling relationship of a thumb passive pulley among a structure of the thumb module 3000 according to at least one example embodiment of the present disclosure.

The thumb module 3000 may include a first thumb frame 3100, a second thumb frame 3200, and a third thumb frame 3300. The thumb module 3000 may further include a first thumb passive pulley 3610 and a second thumb passive pulley 3620.

The first thumb passive pulley 3610 may correspond to an interphalangeal (IP) joint, and the second thumb passive pulley 3620 may correspond to a metacarpophalangeal (MP) joint.

The thumb module 3000 may be configured such that the first thumb passive pulley 3610 is disposed at a point where the first thumb frame 3100 and the second thumb frame 3200 are connected. The first thumb passive pulley 3610 may be disposed in parallel with the first thumb active pulley 3110.

In addition, the thumb module 3000 may be configured such that the second thumb passive pulley 3620 is disposed at a point where the second thumb frame 3200 and the third thumb frame 3300 are connected. The second thumb passive pulley 3620 may include an extension spring 3630.

The first thumb passive pulley 3610 may be connected to a thumb ORL cable 3520. The thumb ORL cable 3520 may be fixed to an upper side of the first thumb frame 3100, wound around the first thumb passive pulley 3610, wound around the second thumb passive pulley 3620, and then fixed to a lower side of the third thumb frame 3300.

The thumb ORL cable 3520 may operate passively by an external force applied to the thumb module 3000.

Specifically, when an external force is generated, the second thumb passive pulley 3620 may rotate by a restoring force of the extension spring 3630. The thumb ORL cable 3520 may move while being guided along an outer circumferential surface of the second thumb passive pulley 3620 in response to the rotation of the second thumb passive pulley 3620, and the thumb ORL cable 3520 may be pulled in a direction in which the second thumb passive pulley 3620 is restored.

The first thumb passive pulley 3610 connected to the thumb ORL cable 3520 may rotate in association with the rotation of the second thumb passive pulley 3620. In a state in which a palm of the hand faces toward the right side, when the thumb module 3000 is viewed from a left side, the thumb ORL cable 3520 may be configured such that, based on the thumb ORL cable 3520 starting from the first thumb frame 3100, the thumb ORL cable 3520 is rotated in a clockwise direction at the first thumb passive pulley 3610 and rotated in a counterclockwise direction at the second thumb passive pulley 3620. Accordingly, the second thumb frame 3200 may rotate in a bending direction by the second thumb passive pulley 3620 corresponding to the MP joint, and the first thumb frame 3100 may rotate in a virtual claw direction in association with the rotation of the MP joint by the first thumb passive pulley 3610 corresponding to the IP joint.

Accordingly, the thumb module 3000 may be aligned such that an end thereof is directed toward an object, and may operate in a form of contacting and pressing the object.

The extension spring 3630 may be disposed at a point where the second thumb frame 3200 and the third thumb frame 3300 are connected.

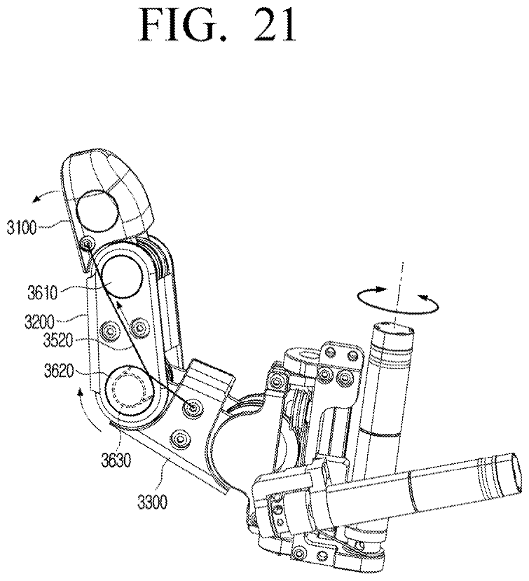

FIG. 21 is a diagram illustrating an operation of the thumb module 3000 by a passive pulley according to at least one example embodiment of the present disclosure.

Referring to FIG. 21, the thumb module 3000 may include the first thumb frame 3100, the second thumb frame 3200, and the third thumb frame 3300. The thumb module 3000 may further include the first thumb passive pulley 3610 and the second thumb passive pulley 3620. In addition, the second thumb passive pulley 3620 may include the extension spring 3630.

The first thumb passive pulley 3610 may correspond to the interphalangeal (IP) joint, and the second thumb passive pulley 3620 may correspond to the metacarpophalangeal (MP) joint.

When an external force is applied, each frame of the thumb module 3000 may rotate. At this time, the extension spring 3630 disposed at the second thumb passive pulley 3620 may be deformed by the rotation of the second thumb passive pulley 3620. In addition, the extension spring 3630 may provide a restoring force for returning the second thumb passive pulley 3620 to an original state. The restoring force of the extension spring 3630 may prevent excessive inward rotation of the second thumb passive pulley 3620 corresponding to the MP joint.

Accordingly, the thumb module 3000 may operate in a form of stably pressing an object by passive driving, thereby stably grasping the object.

A finger according to at least one embodiment of the present disclosure may include a plurality of frames, a plurality of shafts sequentially connecting the plurality of frames, an actuator, and a plurality of active pulleys disposed on each of the plurality of shafts and connected to the actuator through at least one first cable.

The at least one first cable may include an extension cable wound in a first direction along a back side of the finger at each of the plurality of active pulleys, and a bending cable wound in the first direction along a palm side of the finger at each of the plurality of active pulleys.

When the actuator rotates in the first direction to extend the finger, a total length of the extension cable may decrease, and a total length of the bending cable may increase by a length corresponding to the decrease in the extension cable.

When the actuator rotates in a second direction opposite to the first direction to bend the finger, a total length of the bending cable may decrease, and a total length of the extension cable may increase by a length corresponding to the decrease in the bending cable.

The finger may include a plurality of passive pulleys disposed on each of the plurality of shafts and connected to each other by a plurality of second cables, and a spring module in which one of the plurality of second cables is wound to provide a restoring force to the plurality of passive pulleys.

In a case where an external force is applied to the plurality of frames, the spring module may rotate the plurality of passive pulleys in a restoring direction in association with each other by the plurality of second cables by the restoring force of the spring module.

The plurality of active pulleys and the plurality of passive pulleys may be disposed in parallel on the plurality of shafts, and may be independently rotatable.

Each of the plurality of active pulleys may include an extension slot and a bending slot arranged side by side on an outer circumferential surface. The extension cable may be wound in the extension slot. The bending cable may be wound in the bending slot by the actuator.

The actuator may include an active drive pulley to connect the first cable connected to each of the plurality of active pulleys. The extension cable and the bending cable may be connected to each other in a state of being wound in grooves formed in the active drive pulley.

The finger may include a tension member (e.g., a tensioner) configured to apply tension to the at least one first cable such that the at least one first cable is not separated from the plurality of active pulleys in a case where the at least one first cable connected to the plurality of active pulleys moves in response to driving of the actuator.

The plurality of active pulleys may include a first active pulley connected to a first shaft positioned at a distal interphalangeal (DIP) joint, a second active pulley connected to a second shaft positioned at a proximal interphalangeal (PIP) joint, and a third active pulley connected to a third shaft positioned at a metacarpophalangeal (MCP) joint.

The at least one first cable may be wound in the same rotational direction on each of the first active pulley, the second active pulley, and the third active pulley.

Each of the plurality of passive pulleys may include a first passive pulley connected to a first shaft positioned at the DIP joint, a second passive pulley connected to a second shaft positioned at the PIP joint, and a third passive pulley connected to a third shaft positioned at the MCP joint.

The at least one second cable may include an Oblique Retinacular Ligament (ORL) cable wound in opposite directions on outer circumferential surfaces of the first passive pulley and the second passive pulley, and a Lumbrical Muscle (LUM) cable wound in opposite directions on outer circumferential surfaces of the second passive pulley and the third passive pulley.

The second passive pulley may include an ORL slot and a LUM slot arranged side by side on an outer circumferential surface. The ORL slot may be configured such that the ORL cable is in the ORL slot, and the LUM slot may be configured such that the LUM cable is wound in the LUM slot.

The spring module may include a passive drive pulley on which the LUM cable is wound and a torsion spring coupled to the passive drive pulley to provide the restoring force for returning the passive drive pulley to an original position.

A hand according to at least one embodiment of the present disclosure may include a plurality of fingers, a thumb module disposed on one side of the plurality of fingers, and a palm module, the palm module including a plurality of actuators for driving each of the plurality of fingers.

Each of the plurality of fingers may include a plurality of frames, a plurality of shafts sequentially connecting the plurality of frames, and a plurality of active pulleys disposed on each of the plurality of shafts and connected to one of the plurality of actuators by at least one first cable.

The at least one first cable may include an extension cable wound in a first direction along a back side of the finger at each of the plurality of active pulleys and a bending cable wound in the first direction along a palm side of the finger at each of the plurality of active pulleys.

In a case where the actuator rotates in the first direction to extend the finger, a total length of the extension cable may decrease, and a total length of the bending cable may increase by a length corresponding to the decrease in the extension cable.

When the actuator rotates in a second direction opposite to the first direction to bend the finger, a total length of the bending cable may decrease, and a total length of the extension cable may increase by a length corresponding to the decrease in the bending cable.

Each of the plurality of fingers may include a plurality of passive pulleys disposed on each of the plurality of shafts and connected to each other through a plurality of second cables, and a spring module in which one of the plurality of second cables is wound to provide a restoring force to the plurality of passive pulleys.

In a case where an external force is applied to the plurality of frames, the spring module may rotate the plurality of passive pulleys in a restoring direction in association with each other by the plurality of second cables by the restoring force of the spring module.

The plurality of actuators may be disposed in a horizontal alignment, and may be respectively connected to the at least one first cable.

The plurality of actuators may be arranged in alignment along a longitudinal direction of the finger, and may be respectively connected to the at least one first cable.

The thumb module may include a thumb actuator for driving each joint of the thumb module and a rotation actuator for rotating in a direction perpendicular to a bottom surface of the palm module.

Each of the plurality of active pulleys may include an extension slot and a bending slot arranged side by side on an outer circumferential surface. The extension cable may be wound in the extension slot in the first direction, and the bending cable may be wound in the bending slot in the second direction opposite to the first direction.

The plurality of active pulleys may include a first active pulley connected to a first shaft positioned at the DIP joint among the plurality of shafts, a second active pulley connected to a second shaft positioned at the PIP joint among the plurality of shafts, and a third active pulley connected to a third shaft positioned at the MCP joint among the plurality of shafts.

The at least one first cable may be wound in the same rotational direction on each of the first active pulley, the second active pulley, and the third active pulley.

Each of the plurality of passive pulleys may include a first passive pulley connected to a first shaft located at the DIP joint among the plurality of shafts, a second passive pulley connected to a second shaft located at the PIP joint among the plurality of shafts, and a third passive pulley connected to a third shaft located at the MCP joint among the plurality of shafts.

The at least one second cable may include an Oblique Retinacular Ligament ORL) cable wound in opposite directions on outer circumferential surfaces of the first passive pulley and the second passive pulley, and a Lumbrical Muscle (LUM) cable wound in opposite directions on outer circumferential surfaces of the second passive pulley and the third passive pulley

A robot apparatus according to at least one embodiment of the present disclosure may include a main body, a driving apparatus configured to move the main body, at least one robot arm on one side of the body, and a hand connected to the at least one robot arm.

The hand may include a plurality of fingers, a thumb module on one side of the plurality of fingers, and a palm module including a plurality of actuators for driving each of the plurality of fingers.

Each of plurality of fingers may include a plurality of frames, a plurality of shafts sequentially connecting the plurality of frames, and a plurality of active pulleys on each of the plurality of shafts and connected to an actuator, from among the plurality of actuators, by at least one first cable.

The at least one first cable may include an extension cable wound in a first direction along a back side of the finger at each of the plurality of active pulleys, and a bending cable wound in the first direction along a palm side of the finger at each of the plurality of active pulleys.

The at least one first cable may be configured such that, in a case where the actuator rotates in a first direction to extend the finger, a total length of the extension cable decreases, and a total length of the bending cable increases by a length corresponding to the decrease in the total length of the extension cable.

The at least one first cable may be configured such that, in a case where the actuator rotates in a second direction opposite to the first direction to bend the finger, a total length of the bending cable decreases, and a total length of the extension cable increases by a length corresponding to the decrease in the total length of the bending cable.

Each of the plurality of fingers may include a plurality of passive pulleys disposed on each of the plurality of shafts and connected to each other through a plurality of second cables, and a spring module to which one of the plurality of second cables is wound to provide a restoring force to the plurality of passive pulleys.

In a case where an external force is applied to the plurality of frames, the spring module may rotate the plurality of passive pulleys in a restoring direction in association with each other by the plurality of second cables by the restoring force of the spring module.

Each of the elements described in the present disclosure may be configured with one or more components, and names of the relevant elements may vary according to the types of fingers, hands, and the robot apparatuses including the same.

In the above, various example embodiments of the present disclosure have been described individually, but the configuration and operation of each of the example embodiments may be implemented in combination with at least one other of the example embodiments and/or other embodiments.

While example embodiments of the present disclosure have been described above with reference to the accompanying drawings, it will be understood that the example embodiments are intended to be illustrative, not limiting. It will be understood by those skilled in the art that various changes in form and details may be made therein without departing from the spirit and scope of the present disclosure, including the appended claims and their equivalents.

What is claimed is:

1. A finger, comprising:
a plurality of frames;
a plurality of shafts sequentially connecting the plurality of frames;
an actuator; and
a plurality of active pulleys at the plurality of shafts, respectively, the plurality of active pulleys connected to the actuator by at least one first cable,
wherein the at least one first cable comprises:
an extension cable that is wound in a first direction along a back side of the finger at each of the plurality of active pulleys; and
a bending cable that is wound in the first direction along a palm side of the finger at each of the plurality of active pulleys,
wherein, in a case where the actuator rotates in the first direction to extend the finger, a total length of the extension cable decreases, and a total length of the bending cable increases by a length corresponding to a decreased length of the extension cable, and
wherein, in a case where the actuator rotates in a second direction opposite to the first direction to bend the finger, the total length of the bending cable decreases, and the total length of the extension cable increases by a length corresponding to a decreased length of the bending cable.

2. The finger of claim 1, further comprising:
a plurality of passive pulleys at the plurality of shafts, respectively, the plurality of passive pulleys connected to each other by a plurality of second cables; and
a spring module to which one of the plurality of second cables is wound to provide a restoring force to the plurality of passive pulleys,
wherein, in a case where an external force is applied to the plurality of frames, the plurality of passive pulleys are rotated in a restoring direction in association with each other by the plurality of second cables by the restoring force of the spring module.

3. The finger of claim 2, wherein the plurality of active pulleys and the plurality of passive pulleys are disposed in parallel on the plurality of shafts, and are independently rotatable.

4. The finger of claim 1, wherein each of the plurality of active pulleys comprises:
an extension slot and a bending slot disposed side by side on an outer circumferential surface,
wherein the extension cable is wound in the extension slot, and
wherein the bending cable is wound in the bending slot via the actuator.

5. The finger of claim 4, wherein the actuator comprises:
an active drive pulley that is connected to the at least one first cable connected to each of the plurality of active pulleys, and
wherein the extension cable and the bending cable are connected to each other in a state of being wound in a groove of the active drive pulley.

6. The finger of claim 4, further comprising:
a tensioner configured to apply tension to the at least one first cable such that the at least one first cable is not separated from the plurality of active pulleys in a case where the at least one first cable connected to the plurality of active pulleys moves in response to driving of the actuator.

7. The finger of claim 1, wherein the plurality of active pulleys comprises:
a first active pulley connected to a first shaft located at a distal interphalangeal (DIP) joint among the plurality of shafts;
a second active pulley connected to a second shaft located at a proximal interphalangeal (PIP) joint among the plurality of shafts; and
a third active pulley connected to a third shaft located at a metacarpophalangeal (MCP) joint among the plurality of shafts,
wherein the at least one first cable is wound on each of the first active pulley, the second active pulley, and the third active pulley in a same rotational direction.

8. The finger of claim 2, wherein each of the plurality of passive pulleys comprises:
a first passive pulley connected to a first shaft located at a distal interphalangeal (DIP) joint among the plurality of shafts;
a second passive pulley connected to a second shaft located at a proximal interphalangeal (PIP) joint among the plurality of shafts; and
a third passive pulley connected to a third shaft located at a metacarpophalangeal (MCP) joint among the plurality of shafts, and
wherein the plurality of second cables comprises:
an Oblique Retinacular Ligament (ORL) cable that is wound on an outer circumferential surface of the first passive pulley and an outer circumferential surface of the second passive pulley in opposite directions to each other; and
a Lumbrical Muscle (LUM) cable that is wound on the outer circumferential surface of the second passive pulley and an outer circumferential surface of the third passive pulley in opposite directions to each other.

9. The finger of claim 8, wherein the second passive pulley comprises:
an ORL slot and a LUM slot disposed side by side on an outer circumferential surface of the second passive pulley,
wherein the ORL cable is in the ORL slot, and
wherein the LUM cable is wound in the LUM slot.

10. The finger of claim 9, wherein the spring module comprises:
a passive drive pulley on which the LUM cable is wound; and
a torsion spring connected to the passive drive pulley, the torsion spring configured to provide the restoring force for returning the passive drive pulley to an original position.

11. A hand, comprising:
a plurality of fingers;
a thumb module at one side of the plurality of fingers; and
a palm module comprising a plurality of actuators, the plurality of actuators configured to drive each of the plurality of fingers,
wherein each of the plurality of fingers comprises:
a plurality of frames;
a plurality of shafts that sequentially connect the plurality of frames; and
a plurality of active pulleys at the plurality of shafts, respectively, the plurality of active pulleys connected to one of the plurality of actuators by at least one first cable,
wherein the at least one first cable comprises:
an extension cable that is wound in a first direction along a back side of a finger, from among the plurality of fingers, at each of the plurality of active pulleys of the finger; and
a bending cable that is wound in the first direction along a palm side of the finger at each of the plurality of active pulleys of the finger,
wherein, in a case where an actuator from among the plurality of actuators rotating in a first direction to extend the finger, a total length of the extension cable decreases, and a total length of the bending cable increases by a length corresponding to a decrease in the total length of the extension cable, and
wherein, in a case where the actuator rotates in a second direction opposite to the first direction to bend the finger, the total length of the bending cable decreases, and the total length of the extension cable increases by a length corresponding to a decrease in the total length of the bending cable.

12. The hand of claim 11, wherein each of the plurality of fingers further comprises:
a plurality of passive pulleys at the plurality of shafts, respectively, the plurality of passive pulleys connected to each other by a plurality of second cables; and
a spring module in which one of the plurality of second cables is wound to provide a restoring force to the plurality of passive pulleys, and
wherein, in a case where an external force is applied to the plurality of frames, the plurality of passive pulleys rotate in a restoring direction in association with each other through the plurality of second cables by the restoring force of the spring module.

13. The hand of claim 11, wherein the plurality of actuators are disposed in a horizontal alignment, and are respectively connected to the at least one first cable.

14. The hand of claim 11, wherein the plurality of actuators are arranged in alignment along a length direction of the finger, and are respectively connected to the at least one first cable.

15. The hand of claim 11, wherein the thumb module comprises:
a thumb actuator configured to drive at least one joint of the thumb module; and
a rotation actuator configured to rotate in a direction perpendicular to a bottom surface of the palm module.

16. The hand of claim 11, wherein each of the plurality of active pulleys comprises:
an extension slot and a bending slot disposed side by side on an outer circumferential surface,
wherein the extension cable is wound in the extension slot in the first direction, and
wherein the bending cable is wound in the bending slot in a second direction opposite to the first direction.

17. The hand of claim 11, wherein the plurality of active pulleys comprises:
a first active pulley connected to a first shaft located at a distal interphalangeal (DIP) joint among the plurality of shafts;
a second active pulley connected to a second shaft located at a proximal interphalangeal (PIP) joint among the plurality of shafts; and
a third active pulley connected to a third shaft located at a metacarpophalangeal (MCP) joint among the plurality of shafts,
wherein the at least one first cable is wound on each of the first active pulley, the second active pulley, and the third active pulley in a same rotational direction.

18. The hand of claim 12, wherein each of the plurality of passive pulleys comprises:
a first passive pulley connected to a first shaft located at a distal interphalangeal (DIP) joint among the plurality of shafts;
a second passive pulley connected to a second shaft located at a proximal interphalangeal (PIP) joint among the plurality of shafts; and
a third passive pulley connected to a third shaft located at a metacarpophalangeal (MCP) joint among the plurality of shafts, and
wherein the plurality of second cables comprises:
an Oblique Retinacular Ligament (ORL) cable that is wound in opposite directions on an outer circumferential surface of the first passive pulley and an outer circumferential surface of the second passive pulley; and
a Lumbrical Muscle (LUM) cable that is wound in opposite directions on the outer circumferential surface of the second passive pulley and an outer circumferential surface of the third passive pulley.

19. A robot apparatus, comprising:
a main body;
a driving apparatus configured to move the main body;
at least one robot arm disposed on one side of the main body; and
a hand connected to the at least one robot arm,
wherein the hand comprises:
a plurality of fingers;
a thumb module on one side of the plurality of fingers; and
a palm module comprising a plurality of actuators, the plurality of actuators configured to drive each of the plurality of fingers,
wherein each of the plurality of fingers comprises:
a plurality of frames;
a plurality of shafts that sequentially connect the plurality of frames; and
a plurality of active pulleys at the plurality of shafts, respectively, the plurality of active pulleys connected to an actuator, from among the plurality of actuators, by at least one first cable,
wherein the at least one first cable comprises:
an extension cable that is wound in a first direction along a back side of a finger, from among the plurality of fingers, at each of the plurality of active pulleys of the finger; and
a bending cable that is wound in the first direction along a palm side of the finger at each of the plurality of active pulleys of the finger,
wherein, in a case where the actuator rotates in a first direction to extend the finger, a total length of the extension cable decreases, and a total length of the bending cable increases by a length corresponding to a decrease in the total length of the extension cable, and
wherein, in a case where the actuator rotates in a second direction opposite to the first direction to bend the finger, the total length of the bending cable decreases, and the total length of the extension cable increases by a length corresponding to a decrease in the total length of the bending cable.

20. The robot apparatus of claim 19, wherein each the plurality of fingers further comprises:
a plurality of passive pulleys at the plurality of shafts, respectively, the plurality of passive pulleys connected to each other by a plurality of second cables; and
a spring module in which one of the plurality of second cables is wound to provide a restoring force to the plurality of passive pulleys,
wherein, in a case where an external force is applied to the plurality of frames, the plurality of passive pulleys rotate in a restoring direction in association with each other by the plurality of second cables by the restoring force of the spring module.
